(19) United States
(12) Patent Application Publication
(10) Pub. No.: US 2026/0252587 A1
(43) Pub. Date: Aug. 27, 2026

(54) SYSTEM

(71) Applicant: SoftBank Group Corp., Tokyo (JP)

(72) Inventor: Hiroe CHISHIMA, Tokyo (JP)

(73) Assignee: SoftBank Group Corp., Tokyo (JP)

(21) Appl. No.: 19/536,291

(22) Filed: Feb. 11, 2026

(30) Foreign Application Priority Data
Feb. 21, 2025 (JP) 2025-027065

(51) Int. Cl. G06F 16/28; G06F 40/143; G06F 40/166; G06F 40/30

(52) U.S. Cl. CPC G06F 16/285; G06F 40/143; G06F 40/166; G06F 40/30

(57) ABSTRACT

The system according to the embodiment comprises a receiving unit, a generation unit, a display unit, and an editing unit. The receiving unit uploads a PDF file or URL. The generation unit analyzes a document uploaded by the receiving unit and generates a summary based on a request. The display unit displays the summary generated by the generation unit on a chat screen. The editing unit creates a document based on the summary generated by the generation unit.

### CROSS-REFERENCE TO RELATED APPLICATION

The present application claims priority to and incorporates by reference the entire contents of Japanese Patent Application No. 2025-027065 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that it is difficult to efficiently summarize uploaded documents in response to a request and support document creation.

### SUMMARY OF THE INVENTION

The system according to the embodiment comprises a receiving unit, a generation unit, a display unit, and an editing unit. The receiving unit uploads a PDF file or URL. The generation unit analyzes a document uploaded by the receiving unit and generates a summary based on a request. The display unit displays the summary generated by the generation unit on a chat screen. The editing unit creates a document based on the summary generated by the generation unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

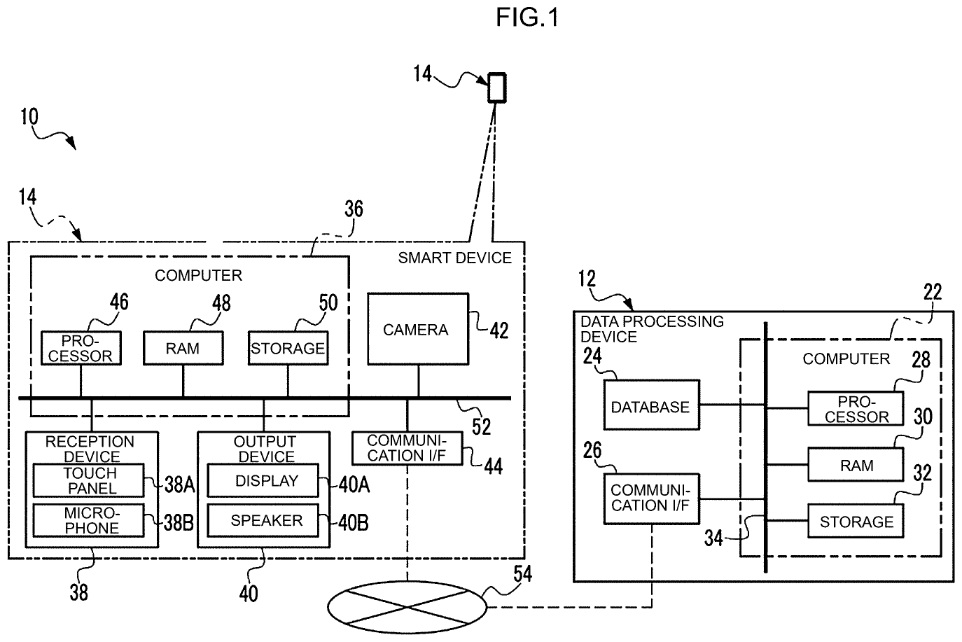

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

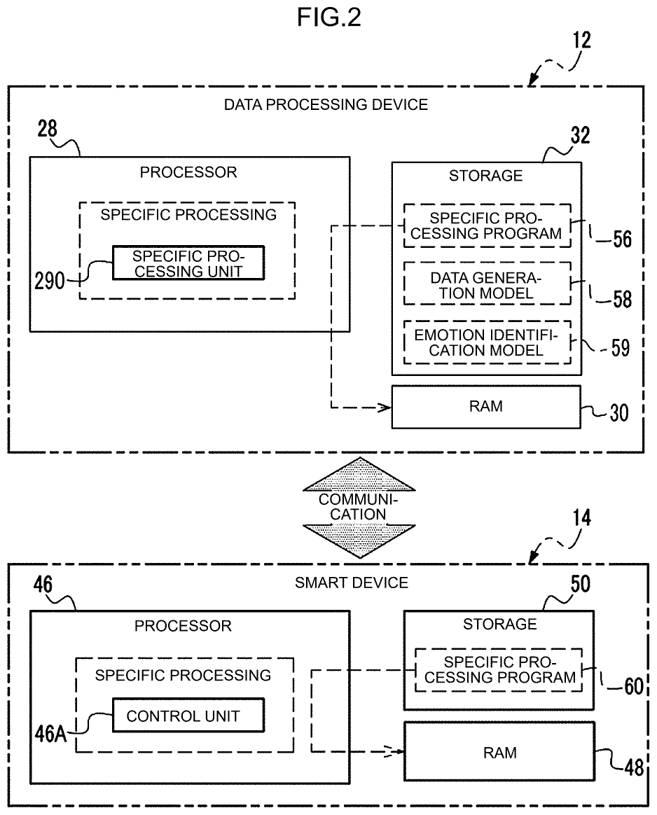

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The document creation support system according to the embodiment of the present invention is a system that summarizes the overview of a document in response to a request by uploading a PDF file or URL, thereby supporting document creation. In this document creation support system, when a user uploads a PDF file or URL, a generative AI analyzes the uploaded document and generates a summary in response to the request. The generated summary is displayed on a chat screen. Furthermore, the user can use the summary in their own editing screen (document, slide, code) to create documents. In addition, since the original page of the PDF or URL is also displayed, the user can proceed with their work while referring to the original document. As a result, the efficiency of document creation is improved and the user's workload is reduced. For example, when a user uploads a PDF file or URL, the user only needs to select the file or URL to be uploaded. For instance, meeting minutes, research papers in PDF format, or website URLs can be uploaded. Next, the generative AI analyzes the uploaded document and generates a summary in response to the request. The generative AI understands the content of the document and extracts important points to create the summary. For example, it can extract key topics and decisions from meeting minutes, or main conclusions and findings from research papers. The generated summary is displayed on the chat screen. The user can check the summary created by the generative AI on the chat screen. For example, summaries of meeting minutes or research papers are displayed. Based on this summary, the user can determine the direction of document creation. In addition, the user can use the summary in their own editing screen (document, slide, code) to create documents. For example, the user can create presentation slides based on the summary of meeting minutes, or write a report based on the summary of a research paper. This improves the efficiency of document creation and reduces the user's workload. Furthermore, since the original page of the PDF or URL is also displayed, the user can refer to the original document while checking the summary and add necessary information. This improves the accuracy of document creation and enables the user to create documents tailored to their needs. Thus, the document creation support system can improve the efficiency of document creation and reduce the workload for users. Specifically, the document creation support system is composed of multiple modules such as a receiving unit, a generation unit, a display unit, and an editing unit. The system receives PDF files or URLs uploaded by the user at the receiving unit, and performs preprocessing such as text extraction or HTML parsing in a preprocessing unit. For example, in the case of a PDF file, text is extracted page by page, and in the case of a URL, the main text is extracted from the HTML. The extracted text data is input to the generation unit, which uses a large language model (for example, a Transformer architecture with billions of parameters). The input data may include a text array of up to 4096 tokens, and, in the case of multimodal support, image embedding vectors. Specific examples include the text of meeting minutes (e.g., “Jun. 1, 2024, attendees: A, B, C . . . Agenda 1: Progress of new product . . . ”) or the body of a research paper (e.g., “This study aims to improve image classification accuracy using deep learning . . . ”). The large language model in the generation unit calculates importance scores from the input text and extracts important sentences using an attention mechanism. The output is generated as summary text (e.g., “In Agenda 1, the progress of the new product was reported, and it was decided that A would submit a design proposal by the next meeting.” or “This paper proposes a novel CNN architecture and reports improved accuracy on ImageNet.”). The output format can support multiple types, such as text summaries, bullet points, or tagged structured data. The generated summary is sent to the display unit, where it is rendered on the chat screen as text cards or interactive elements (such as detail display buttons or related document links). The user can check this summary and transfer it by drag-and-drop to the document editor, slide creation tool, or code editor in the editing unit. The editing unit also provides AI-based auto-completion functions (e.g., automatic generation of slide titles, reference list suggestions, code snippet completion). Furthermore, the original PDF or URL can be displayed side-by-side or as a popup in the display unit, allowing the user to refer to both the summary and the original text simultaneously during editing. This series of processes, unlike conventional manual summarization and document creation by humans, utilizes computer-specific unconventional methods such as attention operations in high-dimensional vector spaces, rule-based extraction of important sentences, and AI-based auto-completion, thereby achieving significant improvements in processing speed, homogenization of summary accuracy, and reduction of workload through automation of editing tasks. Application fields include corporate meeting document creation, academic paper review, educational material summarization, extraction of key points from administrative documents, and automatic generation of program specifications, among others.

The document creation support system according to the embodiment comprises a receiving unit, a generation unit, a display unit, and an editing unit. The receiving unit allows a user to upload PDF files or URLs. The files or URLs uploaded by the user may include, for example, meeting minutes, research papers, website URLs, but are not limited to such examples. The receiving unit enables the user to easily upload files or URLs using, for example, drag-and-drop or a file selection dialog. The generation unit uses a generative AI to analyze the uploaded document and generate a summary in response to a request. The generative AI, for example, uses a text generation AI (such as an LLM) to analyze the document and extract important points to create the summary. The generation unit can also use a generative AI to understand the content of the document and generate a summary in response to a request. For example, the generative AI can extract key topics and decisions from meeting minutes, and main conclusions and findings from research papers. The display unit displays the summary generated by the generation unit on a chat screen. The chat screen can display the summary in text format or card format, for example. The display unit can also display the summary created by the generative AI in a format that includes interactive elements. For example, the user can check the details of the summary or request additional information. The editing unit provides an editing screen for the user to create documents based on the summary. The editing screen may include, for example, a text editor, slide creation tool, or code editor, but is not limited to such examples. The editing unit enables the user to create presentation slides or reports based on the summary, for example. As a result, the document creation support system according to the embodiment can improve the efficiency of document creation and reduce the user's workload. Some or all of the above-described processing in the generation unit may be performed using a generative AI, or may be performed without using a generative AI. For example, the generation unit may input the uploaded document to a generative AI and have the generative AI perform document analysis and summary generation. Some or all of the above-described processing in the display unit may be performed using AI, or may be performed without using AI. For example, the display unit may input the generated summary to an AI model and have the AI select the optimal display format. Some or all of the above-described processing in the editing unit may be performed using AI, or may be performed without using AI. For example, the editing unit may have AI assist the user's editing work. As a result, the document creation support system according to the embodiment can improve the efficiency of document creation and reduce the user's workload. Specifically, the document creation support system operates by linking the modules of the receiving unit, generation unit, display unit, and editing unit, thereby enabling high-speed processing of large volumes of documents and flexible summary generation tailored to individual user needs, which were difficult with conventional manual work by humans. The system receives PDF files or URLs uploaded by the user at the receiving unit, and performs preprocessing such as text extraction or HTML parsing in a preprocessing unit. For example, in the case of a PDF file, text is extracted page by page, and in the case of a URL, the main text is extracted from the HTML. The extracted text data is input to the generation unit, which uses a large language model (for example, a Transformer architecture with billions of parameters). The input data may include a text array of up to 4096 tokens, and, in the case of multimodal support, image embedding vectors. Specific examples include the text of meeting minutes (e.g., “Jun. 1, 2024, attendees: A, B, C . . . Agenda 1: Progress of new product . . . ”) or the body of a research paper (e.g., “This study aims to improve image classification accuracy using deep learning . . . ”). The large language model in the generation unit calculates importance scores from the input text and extracts important sentences using an attention mechanism. The output is generated as summary text (e.g., “In Agenda 1, the progress of the new product was reported, and it was decided that A would submit a design proposal by the next meeting.” or “This paper proposes a novel CNN architecture and reports improved accuracy on ImageNet.”). The output format can support multiple types, such as text summaries, bullet points, or tagged structured data. The generated summary is sent to the display unit, where it is rendered on the chat screen as text cards or interactive elements (such as detail display buttons or related document links). The user can check this summary and transfer it by drag-and-drop to the document editor, slide creation tool, or code editor in the editing unit. The editing unit also provides AI-based auto-completion functions (e.g., automatic generation of slide titles, reference list suggestions, code snippet completion). Furthermore, the original PDF or URL can be displayed side-by-side or as a popup in the display unit, allowing the user to refer to both the summary and the original text simultaneously during editing. This series of processes, unlike conventional manual summarization and document creation by humans, utilizes computer-specific unconventional methods such as attention operations in high-dimensional vector spaces, rule-based extraction of important sentences, and AI-based auto-completion, thereby achieving significant improvements in processing speed, homogenization of summary accuracy, and reduction of workload through automation of editing tasks. Application fields include corporate meeting document creation, academic paper review, educational material summarization, extraction of key points from administrative documents, and automatic generation of program specifications, among others.

The receiving unit allows a user to upload a PDF file or URL. When uploading a PDF file or URL, the user can use, for example, drag-and-drop or a file selection dialog. For example, the user can upload meeting minutes or research papers in PDF format by drag-and-drop. The user can also upload a website URL using a file selection dialog. As a result, by uploading a PDF file or URL, the system can analyze the document and generate a summary. Some or all of the above-described processing in the receiving unit may be performed using AI, or may be performed without using AI. For example, the receiving unit may input the uploaded file or URL to AI and have the AI perform the upload processing. Specifically, the receiving unit provides an HTML5-based drag-and-drop area or a standard OS file selection dialog as a user interface. The receiving unit automatically determines the file extension or MIME type of the uploaded file, performs text extraction processing page by page for PDFs, and issues HTTP requests to obtain the HTML body for URLs, extracting the main text via DOM parsing. The extracted text data is normalized in UTF-8 encoding and preprocessed by removing line breaks and special characters. When using AI, the receiving unit inputs metadata of the uploaded file or URL (e.g., file name, upload time, file size, URL domain) and a sample of the extracted text as input vectors to the AI model. Examples of input include {“filename”: “minutes20240601.pdf”, “size”: 2.3 MB, “text_sample”: “Jun. 1, 2024, attendees: A, B, C . . . ”} or {“url”: “https://example.com/paper123”, “text_sample”: “This study uses deep learning . . . ”}. The AI model determines the file type, estimates upload priority, optimizes the timing of upload completion notifications, and outputs an upload permission flag (e.g., 1=allowed, 0=denied), recommended upload method (e.g., drag-and-drop, dialog), and user notification message (e.g., “Upload completed”). These outputs are used for subsequent processing in the receiving unit (e.g., data transfer to the preprocessing unit, notification display in the user interface). When not using AI, the receiving unit determines file type and size limits based on rules and proceeds with the upload process. As a result, the receiving unit reduces the user's operational burden, decreases upload failure rates, and improves the overall processing efficiency of the system. Application fields include corporate document management systems, academic paper submission platforms, and electronic application systems for administrative procedures.

The generation unit can analyze documents uploaded by a generative AI and generate a summary in response to a request. The generation unit uses a generative AI to analyze the uploaded document and generate a summary in response to a request. The generative AI, for example, uses a text generation AI (such as an LLM) to analyze the document and extract important points to create the summary. The generation unit can also use a generative AI to understand the content of the document and generate a summary in response to a request. For example, the generative AI can extract key topics and decisions from meeting minutes, and main conclusions and findings from research papers. As a result, by analyzing documents with a generative AI and generating summaries in response to requests, the efficiency of document creation is improved. Some or all of the above-described processing in the generation unit may be performed using a generative AI, or may be performed without using a generative AI. For example, the generation unit may input the uploaded document to a generative AI and have the generative AI perform document analysis and summary generation. Specifically, the generation unit inputs text data received from the preprocessing unit (e.g., UTF-8 encoded text array, up to 4096 tokens) to a large language model (Transformer architecture, billions of parameters). The generation unit adds the user's request (e.g., “concise summary,” “detailed summary,” “bullet point format”) as a prompt and performs conditional generation with the model. Examples of input include “meeting minutes text+summary format specification” or “paper body+main conclusion extraction instruction.” The AI model scores important sentences in the input text using an attention mechanism, extracts the top-ranked sentences, and generates a summary using a natural language generation decoder. The output can be a summary text (e.g., “In Agenda 1, the progress of the new product was reported, and it was decided that A would submit a design proposal by the next meeting.”), a bullet point list (e.g., “—New product progress report-A to submit design proposal”), or tagged structured data (e.g., {“topic”: “New product progress”, “action”: “A to submit design proposal”}), among other formats. These outputs are transferred to subsequent display and editing units to support the user's document creation work. Internally, the AI model uses pre-trained weights for autoregressive generation and, as needed, fine-tuning or prompt engineering to improve adaptation to user requests. When not using AI, rule-based key phrase extraction or TF-IDF scoring algorithms are applied. As a result, the generation unit, unlike conventional manual summarization by humans, utilizes attention operations in high-dimensional vector spaces and conditional natural language generation to achieve homogenization of summary accuracy, significant improvement in processing speed, and flexible response to user requests. Application fields include corporate meeting document creation, academic paper review, educational material summarization, and extraction of key points from administrative documents.

The display unit can display a summary created by a generative AI on a chat screen. The display unit displays the summary generated by the generation unit on a chat screen. The chat screen can display the summary in text format or card format, for example. The display unit can also display the summary created by the generative AI in a format that includes interactive elements. For example, the user can check the details of the summary or request additional information. As a result, displaying the summary created by the generative AI on the chat screen makes it easier for the user to check the summary. Some or all of the above-described processing in the display unit may be performed using AI, or may be performed without using AI. For example, the display unit may input the generated summary to an AI model and have the AI select the optimal display format. Specifically, the display unit renders summary data received from the generation unit (e.g., text summary, bullet point list, tagged structured data) on a web-based chat screen. Display formats include simple text boxes, card-type UIs, accordion-style expandable lists, interactive detail display buttons, and related document link buttons, among various UI components. The display unit automatically selects the optimal UI layout by referring to the user's device information (e.g., screen size, OS type, browser type) and past display history. When using AI, the display unit inputs summary data and user context information (e.g., device type, past display preferences, current work mode) as input vectors to the AI model. Examples of input include {“summary_text”: “In Agenda 1, the progress of the new product was reported . . . ”, “device”: “smartphone”, “user_pref”: “card”}. The AI model outputs the optimal display format (e.g., text, card, with detail button), with output examples such as {“display_type”: “card”, “show_detail_button”: true}. These outputs are passed to the web frontend rendering engine and reflected in the actual UI display. When the user clicks on the details of the summary, dynamic display of additional information or related document links is also possible. When not using AI, the display format is switched based on device type or summary length using rule-based logic. As a result, the display unit achieves flexible UI display tailored to the user's environment and needs, greatly improving the visibility and operability of summaries. Application fields include business chat tools, learning support platforms, and administrative document viewing systems.

The editing unit can provide an editing screen for the user to create documents based on the summary. The editing unit provides an editing screen for the user to create documents based on the summary. The editing screen may include, for example, a text editor, slide creation tool, or code editor, but is not limited to such examples. The editing unit enables the user to create presentation slides or reports based on the summary, for example. As a result, by providing an editing screen for the user to create documents based on the summary, the efficiency of document creation is improved. Some or all of the above-described processing in the editing unit may be performed using AI, or may be performed without using AI. For example, the editing unit may have AI assist the user's editing work. Specifically, the editing unit integrates multiple editing modules such as a web-based rich text editor, slide creation tool, and code editor, and provides a UI that allows the user to transfer the summary to the editing screen by drag-and-drop. The editing unit is equipped with AI auto-completion functions that automatically suggest slide titles, headings, reference lists, code snippets, etc., according to the content of the summary. When using AI, the editing unit inputs the content of the document being edited (e.g., text body, slide structure, code fragments), summary information, and the user's past editing history as input vectors to the AI model. Examples of input include {“current_doc”: “New product progress report . . . ”, “summary”: “In Agenda 1 . . . ”, “edit_history”: [“slide”, “report”]}. The AI model outputs auto-completion candidates (e.g., slide titles, references, code completion) and editing support messages (e.g., “Would you like to add a chart here?”). Output examples include {“suggestion”: “Slide title: New product progress report”, “add_reference”: true}. These outputs are presented to the user as sidebars or popups in the editing screen, and the user can reflect the completion content with a single click. When not using AI, template-based completion or rule-based editing support is provided. As a result, the editing unit greatly streamlines the user's editing work and improves the accuracy and consistency of document creation. Application fields include business presentation creation, academic paper writing, educational material editing, and program specification creation.

The display unit can display the original page of a PDF or URL. The display unit displays the original page of a PDF or URL. Methods for displaying the original page may include, for example, display within the browser or display in a separate window, but are not limited to such examples. For example, the display unit allows the user to check the summary and add necessary information while displaying the original page of meeting minutes or research papers. As a result, by displaying the original page of a PDF or URL, the user can proceed with their work while referring to the original document. Some or all of the above-described processing in the display unit may be performed using AI, or may be performed without using AI. For example, the display unit may have AI select the method for displaying the original page. Specifically, the display unit receives input data such as the file path or URL information of the original document received from the generation unit, document type (e.g., PDF, HTML, image), and user device information (e.g., screen resolution, OS type, browser type). For PDFs, the display unit uses a web-based PDF viewer component (e.g., canvas rendering type, SVG conversion type) to achieve high-speed page-by-page rendering. For URLs, the display unit can use a sandboxed iframe or virtual DOM to extract and display only the main text of external sites. When using AI, the display unit inputs metadata of the original document (e.g., file size, page count, URL domain), user's past display history, and current work mode (e.g., editing, viewing) as vectors to an AI model (e.g., Transformer-based layout optimization model). Examples of input include {“file_type”: “pdf”, “page_count”: 12, “device”: “desktop”, “user_pref”: “side_by_side”} or {“url”: “https://example.com/paper123”, “device”: “tablet”, “user_pref”: “popup”}. The AI model outputs the optimal display mode (e.g., side-by-side display, popup display, tab switching display), with output examples such as {“display_mode”: “side_by_side”, “zoom_level”: 100} or {“display_mode”: “popup”, “window_size”: “800×600”}. These outputs are passed to the web frontend rendering engine and reflected in the actual UI display. When the user refers to both the summary and the original document simultaneously, the display unit can also provide synchronized scrolling and highlight linkage functions (e.g., clicking on a key phrase in the summary highlights the corresponding section in the original document). When not using AI, the display mode is switched based on file type or device type using rule-based logic. As a result, the display unit achieves optimal original document display tailored to the user's environment and work purpose, improving editing efficiency through simultaneous reference to the summary and original text, preventing information omissions, and reducing workload. Application fields include corporate meeting document review, academic paper peer review, educational material editing, administrative document proofreading, and program specification verification, among others.

The receiving unit can estimate a user's emotion and adjust the timing of uploading based on the estimated emotion of the user. The receiving unit estimates a user's emotion and adjusts the timing of uploading based on the estimated emotion. For example, if the user is feeling stressed, the timing of uploading is delayed to provide time for relaxation. If the user is in a hurry, the timing of uploading is accelerated to start processing quickly. Furthermore, if the user is focused, the timing of uploading is adjusted to minimize interruptions to their work. As a result, by adjusting the timing of uploading based on the user's emotion, the user's workload can be reduced. Emotion estimation is realized using, for example, an emotion engine or a generative AI with emotion estimation functions. The generative AI may be, for example, a text generation AI (such as an LLM) or a multimodal generative AI, but is not limited to such examples. Some or all of the above-described processing in the receiving unit may be performed using AI, or may be performed without using AI. For example, the receiving unit may input the user's emotion data to a generative AI and have the generative AI perform emotion estimation and adjustment of upload timing. Specifically, the receiving unit combines multiple data sources such as user input interactions (e.g., mouse movement, click frequency, input speed), biometric information (e.g., heart rate from wearable devices, skin conductance), and text input content (e.g., chat messages, comments) to generate input vectors for emotion estimation. Examples of input include {“mouse_speed”: 120, “click_rate”: 3.2, “heart_rate”: 95, “text_sample”: “I'm in a hurry”} or {“mouse_speed”: 40, “click_rate”: 0.8, “heart_rate”: 65, “text_sample”: “Working calmly”}. The AI model uses these multidimensional inputs to output emotion classification (e.g., stress, relaxation, focus, excitement) and calculates recommended upload timing (e.g., immediate, after 5 minutes, after user confirmation). Output examples include {“emotion”: “stress”, “upload_timing”: “after 5 minutes”} or {“emotion”: “in a hurry”, “upload_timing”: “immediate”}. These outputs are used for subsequent processing in the receiving unit (e.g., timing for enabling the upload button, notification display to the user). When not using AI, timing is determined by threshold judgment or rule-based logic based on input values. As a result, the receiving unit achieves flexible upload control tailored to the user's psychological state, minimizing work interruptions, reducing stress, and optimizing user experience. Application fields include corporate stress management support systems, student support platforms in educational settings, and patient data entry support in medical settings.

The receiving unit can analyze a user's past upload history and select an optimal upload method. The receiving unit analyzes a user's past upload history and selects an optimal upload method. For example, the upload method frequently used by the user in the past (drag-and-drop, file selection, etc.) is preferentially suggested. The receiving unit can also suggest the optimal upload method for a specific time of day based on the user's past upload history. Furthermore, the receiving unit can select the optimal upload method based on the types of files the user has uploaded in the past. As a result, by analyzing the user's past upload history, the optimal upload method can be provided. Some or all of the above-described processing in the receiving unit may be performed using AI, or may be performed without using AI. For example, the receiving unit may input the user's upload history data to AI and have the AI select the optimal upload method. Specifically, the receiving unit maintains an upload history database for each user (e.g., upload date and time for the past 30 days, file type, upload method, success/failure flag), and inputs these history data as time series vectors or categorical features to the AI model. Examples of input include {“history”: [{“date”: “2024 Jun. 1”, “method”: “drag_drop”, “file_type”: “pdf”}, {“date”: “2024 Jun. 2”, “method”: “dialog”, “file_type”: “docx”}], “current_time”: “18:00”}. The AI model learns the user's tendencies from these histories and outputs the optimal upload method for the current situation (e.g., time of day, file type), such as drag-and-drop, file selection dialog, or URL input. Output examples include {“recommended_method”: “drag_drop”} or {“recommended_method”: “dialog”}. These outputs are reflected in the receiving unit's UI and presented to the user as recommended methods. When not using AI, the method is determined by simple frequency aggregation or rule-based logic. As a result, the receiving unit achieves a personalized upload experience tailored to each user's operational habits and usage situation, improving operational efficiency, reducing operational errors, and enhancing overall system usability. Application fields include corporate document management systems, academic paper submission platforms, and electronic application systems for administrative procedures.

The receiving unit can perform filtering at the time of uploading based on a user's current project or field of interest. The receiving unit performs filtering at the time of uploading based on a user's current project or field of interest. For example, the receiving unit filters so that only files related to the user's ongoing project are uploaded. The receiving unit can also prioritize uploading files with high relevance based on the user's field of interest. Furthermore, the receiving unit can automatically select and upload necessary files according to the progress of the user's project. As a result, by performing filtering based on the user's current project or field of interest, highly relevant documents can be uploaded. Some or all of the above-described processing in the receiving unit may be performed using AI, or may be performed without using AI. For example, the receiving unit may input the user's project data or field of interest data to AI and have the AI perform filtering. Specifically, the receiving unit inputs project management database information (e.g., project name, progress status, related keywords), field of interest profile (e.g., technical field, business category, past document usage history), and metadata of candidate files for upload (e.g., file name, creation date, tags, content sample) as input features to the AI model. Examples of input include {“project”: “AI development”, “interest”: [“natural language processing”, “image recognition”], “file_candidates”: [{“filename”: “NLP_report.pdf”, “tags”: [“NLP”, “2024”]}, {“filename”: “ImageNet_results.pdf”, “tags”: [“image recognition”, “2023”]}]}. The AI model calculates relevance scores for each file from these inputs and outputs only files above a certain threshold as upload candidates. Output examples include {“selected_files”: [“NLP_report.pdf”]} or {“selected_files”: [“ImageNet_results.pdf”, “NLP_report.pdf”]}. These outputs are reflected in the receiving unit's file selection UI and presented to the user as recommended files. When not using AI, filtering is performed by keyword matching or rule-based logic. As a result, the receiving unit achieves highly relevant document uploads tailored to the user's work situation and interests, preventing the inclusion of unnecessary files, improving work efficiency, and optimizing information management. Application fields include project management systems, research and development support tools, and educational material management.

The receiving unit can estimate a user's emotion and determine the priority of documents to be uploaded based on the estimated emotion of the user. The receiving unit estimates a user's emotion and determines the priority of documents to be uploaded based on the estimated emotion. For example, if the user is feeling stressed, documents with low importance are postponed and documents with high importance are uploaded preferentially. If the user is relaxed, all documents can be uploaded evenly. Furthermore, if the user is in a hurry, the most important document can be uploaded with the highest priority. As a result, by determining the priority of documents to be uploaded based on the user's emotion, important documents can be uploaded preferentially. Emotion estimation is realized using, for example, an emotion engine or a generative AI with emotion estimation functions. The generative AI may be, for example, a text generation AI (such as an LLM) or a multimodal generative AI, but is not limited to such examples. Some or all of the above-described processing in the receiving unit may be performed using AI, or may be performed without using AI. For example, the receiving unit may input the user's emotion data to a generative AI and have the generative AI perform emotion estimation and determination of document priority. Specifically, the receiving unit inputs emotion estimation data (e.g., input interactions, biometric information, text content) and importance metadata of candidate documents for upload (e.g., importance score, submission deadline, project relevance) to the AI model. Examples of input include {“emotion_input”: {“heart_rate”: 110, “text_sample”: “I'm in a hurry”}, “files”: [{“filename”: “urgent_report.pdf”, “importance”: 0.95}, {“filename”: “reference.pdf”, “importance”: 0.3}]}. The AI model integrates emotion classification and document importance to output the upload order (e.g., prioritized list). Output examples include {“upload_order”: [“urgent_report.pdf”, “reference.pdf”]} or {“upload_order”: [“reference.pdf”, “urgent_report.pdf”]}. These outputs are reflected in the receiving unit's upload queue control and user interface. When not using AI, the order is determined by rule-based logic based on emotion state and importance. As a result, the receiving unit achieves flexible document upload control that balances the user's psychological state and business priorities, enabling rapid processing of important documents, reducing user burden, and optimizing work efficiency. Application fields include corporate workflow management, assignment submission support in educational settings, and prioritized data entry in medical settings.

The receiving unit can preferentially upload relevant documents by considering a user's geographic location information at the time of uploading. The receiving unit preferentially uploads relevant documents by considering a user's geographic location information at the time of uploading. For example, if the user is in a specific region, documents related to that region are uploaded preferentially. If the user is traveling, documents related to the travel destination can be uploaded preferentially. Furthermore, if the user is at home, documents related to the household can be uploaded preferentially. As a result, by considering the user's geographic location information, highly relevant documents can be uploaded preferentially. Some or all of the above-described processing in the receiving unit may be performed using AI, or may be performed without using AI. For example, the receiving unit may input the user's geographic location information to AI and have the AI select relevant documents. Specifically, the receiving unit combines multiple geographic features such as latitude and longitude information obtained from the user terminal, region estimation results based on IP address, Wi-Fi access point information, and mobile base station ID to accurately identify the user's current location. The receiving unit also collects metadata of candidate documents for upload (e.g., file name, creation location, related region tags, content sample), vectorizes this information, and inputs it to the AI model. Examples of input include {“location”: “35.6895,139.6917”, “file_candidates”: [{“filename”: “Tokyo_meeting.pdf”, “tags”: [“Tokyo”, “2024”]}, {“filename”: “Osaka_report.pdf”, “tags”: [“Osaka”, “2023”]}]} or {“location”: “Kyoto”, “file_candidates”: [{“filename”: “Kyoto_event.docx”, “tags”: [“Kyoto”, “event”]}]}. The AI model calculates relevance scores between each document and the current location and outputs documents above a certain threshold as priority upload candidates. Output examples include {“selected_files”: [“Tokyo_meeting.pdf”]} or {“selected_files”: [“Kyoto_event.docx”]}. These outputs are reflected in the receiving unit's file selection UI and presented to the user as recommended documents. When not using AI, relevance is determined by matching location tags or rule-based logic. Furthermore, the receiving unit can also take into account the user's movement history and past upload tendencies, automatically prioritizing documents related to travel or business trips. Internally, the AI model embeds geographic features and document metadata in a high-dimensional space and quantitatively evaluates relevance using cosine similarity or attention mechanisms. As a result, the receiving unit achieves document uploads tailored to the user's current location and movement status, preventing the inclusion of unnecessary documents, improving work efficiency, and optimizing information management. Application fields include on-site business support systems, region-specific event document management, automatic organization of business trip reports, regional educational material distribution, and on-site information sharing during disasters, among others.

The receiving unit can analyze a user's social media activity at the time of uploading and upload relevant documents. The receiving unit analyzes a user's social media activity at the time of uploading and uploads relevant documents. For example, the receiving unit uploads relevant documents based on links shared by the user on social media. The receiving unit can also analyze the user's social media posts and upload relevant documents. Furthermore, the receiving unit can upload relevant documents based on information from accounts followed by the user on social media. As a result, by analyzing the user's social media activity, relevant documents can be uploaded. Some or all of the above-described processing in the receiving unit may be performed using AI, or may be performed without using AI. For example, the receiving unit may input the user's social media data to AI and have the AI select relevant documents. Specifically, the receiving unit collects various data such as post history, shared links, followed account lists, post text, hashtags, and like history obtained from social media APIs within the scope permitted by the user, and inputs these as categorical features or text embedding vectors to the AI model. Examples of input include {“posts”: [“Sharing the latest trends in AI technology”, “#image recognition #NLP”], “shared_links”: [“https://example.com/ai_report.pdf”], “following”: [“AI researcher A”, “Educational institution B”]} or {“posts”: [“Attended new product launch event”], “shared_links”: [“https://example.com/event_slide.pptx”]}. The AI model analyzes the content of posts, the content of linked sites, and the specialties of followed accounts, and matches these with metadata of candidate documents for upload (e.g., file name, tags, content sample) to calculate relevance scores. Output examples include {“selected_files”: [“ai_report. pdf”]} or {“selected_files”: [“event_slide. pptx”]}. These outputs are reflected in the receiving unit's file selection UI and presented to the user as recommended documents. When not using AI, relevance is determined by keyword matching or rule-based logic. Internally, the AI model combines text understanding using Transformer architecture and account relationship analysis using graph neural networks to integratively evaluate multiple information sources. As a result, the receiving unit achieves document uploads tailored to the user's latest interests and network status, preventing information omissions, improving work efficiency, and enabling personalized information management. Application fields include marketing document management, academic paper sharing in scholarly communities, educational material recommendation, and automatic organization of event management documents.

The generation unit can estimate a user's emotion and adjust the expression method of the summary based on the estimated emotion of the user. The generation unit estimates a user's emotion and adjusts the expression method of the summary based on the estimated emotion. For example, if the user is relaxed, a detailed summary is generated. If the user is in a hurry, a concise summary can be generated. Furthermore, if the user is excited, a visually appealing summary can be generated. As a result, by adjusting the expression method of the summary based on the user's emotion, a summary suitable for the user can be provided. Emotion estimation is realized using, for example, an emotion engine or a generative AI with emotion estimation functions. The generative AI may be, for example, a text generation AI (such as an LLM) or a multimodal generative AI, but is not limited to such examples. Some or all of the above-described processing in the generation unit may be performed using a generative AI, or may be performed without using a generative AI. For example, the generation unit may input the user's emotion data to a generative AI and have the generative AI adjust the expression method of the summary. Specifically, the generation unit inputs emotion estimation data (e.g., input interactions, biometric information, text content) to an emotion classification AI model (e.g., multimodal Transformer) to estimate emotion labels (e.g., relaxed, in a hurry, excited). Examples of input include {“mouse_speed”: 80, “heart_rate”: 70, “text_sample”: “Working calmly”} or {“mouse_speed”: 150, “heart_rate”: 110, “text_sample”: “I'm in a hurry”}. The AI model inputs the estimated emotion label and user request (e.g., summary format specification) as prompts to a large language model and conditionally generates the expression method of the summary (e.g., detailed explanation, concise summary, with visual effects). Output examples include a detailed summary (e.g., “This document describes the overall picture, issues, solutions, and future prospects of technology A in detail.”), a concise summary (e.g., “Only the overview and main conclusions of technology A are described.”), or a summary with visual effects (e.g., important terms highlighted, color-coded). These outputs are transferred to subsequent display and editing units to optimize the user experience. Internally, the AI model embeds emotion labels and uses them as parameters to control the length, expression style, and decorative elements of the generated text. When not using AI, the expression method is switched by threshold judgment or rule-based logic. As a result, the generation unit achieves flexible summary generation tailored to the user's psychological state, optimizing information delivery, improving work efficiency, and enhancing user satisfaction. Application fields include business report creation, educational material summarization, patient explanation document generation in medical settings, and personalized display of administrative documents.

The generation unit can adjust the level of detail of the summary based on the importance of the document at the time of summary generation. The generation unit adjusts the level of detail of the summary based on the importance of the document at the time of summary generation. For example, a detailed summary is generated for documents with high importance. For documents with low importance, a concise summary can be generated. Furthermore, the length and content of the summary can be adjusted according to the importance of the document. As a result, by adjusting the level of detail of the summary based on the importance of the document, a detailed summary can be provided for important documents. Some or all of the above-described processing in the generation unit may be performed using a generative AI, or may be performed without using a generative AI. For example, the generation unit may input document importance data to a generative AI and have the generative AI adjust the level of detail of the summary. Specifically, the generation unit inputs importance scores assigned to each uploaded document (e.g., continuous values from 0.0 to 1.0, or categorical values such as “high,” “medium,” “low”), submission deadlines, project relevance, and other metadata as input features to the AI model. Examples of input include {“filename”: “urgent_report.pdf”, “importance”: 0.95} or {“filename”: “reference.pdf”, “importance”: 0.3}. The AI model automatically adjusts summary generation parameters (e.g., output length, level of detail, number of extracted sentences) according to the importance score and instructs the large language model to perform conditional generation. Output examples include a detailed summary (e.g., “This report describes the progress, issues, and future responses of Project A in detail.”), or a concise summary (e.g., “Only the progress of Project A is described.”). These outputs are transferred to subsequent display and editing units to support the user's document creation work. Internally, the AI model embeds the importance score and uses it as a parameter for attention mechanisms and decoder output length control. When not using AI, the level of detail is switched by threshold judgment or rule-based logic. As a result, the generation unit achieves flexible summary generation tailored to the business importance and urgency of documents, optimizing information delivery, improving work efficiency, and preventing misunderstandings or omissions. Application fields include corporate workflow management, academic paper review, extraction of key points from administrative documents, and educational material summarization.

The generation unit can apply different summary algorithms according to the category of the document at the time of summary generation. The generation unit applies different summary algorithms according to the category of the document at the time of summary generation. For example, for meeting minutes, the generation unit generates a summary that organizes key points by agenda item. For research papers, the generation unit generates a summary that extracts main conclusions and findings. Furthermore, for news articles, the generation unit can generate a summary that includes important events and background information. As a result, by applying different summary algorithms according to the category of the document, a summary suitable for each category can be provided. Some or all of the above-described processing in the generation unit may be performed using a generative AI, or may be performed without using a generative AI. For example, the generation unit may input document category data to a generative AI and have the generative AI apply the summary algorithm. Specifically, the generation unit inputs category information assigned to each document (e.g., “meeting minutes,” “research paper,” “news article”), content samples, and tag information as input features to the AI model. Examples of input include {“category”: “meeting minutes”, “text_sample”: “Jun. 1, 2024, attendees . . . ”} or {“category”: “research paper”, “text_sample”: “This study . . . ”}. The AI model automatically selects the optimal summary generation algorithm for each category (e.g., agenda segmentation +key point extraction, conclusion extraction+background summarization, event extraction+chronological organization), and combines large language models and rule-based extractors to generate the summary. Output examples include a summary for meeting minutes (e.g., “Agenda 1: New product progress, Agenda 2: Budget approval”), a summary for papers (e.g., “This paper proposes a novel CNN architecture and reports improved accuracy on ImageNet.”), or a summary for news articles (e.g., “On Jun. 1, 2024, a new product launch event was held in major cities.”). These outputs are transferred to subsequent display and editing units to support the user's document creation work. Internally, the AI model switches attention mechanisms, extraction rules, and generation templates using category embedding and conditional branching. When not using AI, rule-based extractors designed for each category are applied. As a result, the generation unit achieves optimal summary generation tailored to the information structure and usage purpose of each document type, improving the accuracy of information delivery, work efficiency, and user satisfaction. Application fields include corporate meeting document creation, academic paper review, news summarization in media organizations, and educational material summarization.

The generation unit can adjust the length of the summary based on the estimated emotion of the user. The generation unit estimates a user's emotion and adjusts the length of the summary based on the estimated emotion. For example, if the user is in a hurry, a short summary that covers the key points is generated. If the user is relaxed, a longer summary with detailed explanations can be generated. Furthermore, if the user is excited, a summary with visually stimulating effects can be generated. As a result, by adjusting the length of the summary based on the user's emotion, a summary suitable for the user can be provided. Emotion estimation is realized using, for example, an emotion engine or a generative AI with emotion estimation functions. The generative AI may be, for example, a text generation AI (such as an LLM) or a multimodal generative AI, but is not limited to such examples. Some or all of the above-described processing in the generation unit may be performed using a generative AI, or may be performed without using a generative AI. For example, the generation unit may input the user's emotion data to a generative AI and have the generative AI adjust the length of the summary. Specifically, the generation unit inputs emotion estimation data (e.g., input interactions, biometric information, text content) to an emotion classification AI model to estimate emotion labels (e.g., in a hurry, relaxed, excited). Examples of input include {“mouse_speed”: 150, “heart_rate”: 110, “text_sample”: “I'm in a hurry”} or {“mouse_speed”: 60, “heart_rate”: 65, “text_sample”: “Working calmly”}. The AI model inputs the estimated emotion label as a prompt to a large language model and conditionally generates the length of the summary (e.g., short, standard, long) and decorative elements (e.g., highlighting, color coding). Output examples include a short summary (e.g., “Only the overview of technology A is described.”), a long summary (e.g., “The background, issues, solutions, and future prospects of technology A are described in detail.”), or a summary with effects (e.g., important terms highlighted in color). These outputs are transferred to subsequent display and editing units to optimize the user experience. Internally, the AI model uses emotion embedding as output length control parameters and decoration control parameters. When not using AI, the length and effects are switched by threshold judgment or rule-based logic. As a result, the generation unit achieves flexible summary generation tailored to the user's psychological state and work situation, optimizing information delivery, improving work efficiency, and enhancing user satisfaction. Application fields include business report creation, educational material summarization, patient explanation document generation in medical settings, and personalized display of administrative documents.

The generation unit can determine the priority of the summary based on the submission timing of the document at the time of summary generation. The generation unit determines the priority of the summary based on the submission timing of the document at the time of summary generation. For example, for documents with an imminent submission deadline, the summary is generated preferentially. For documents with a distant submission deadline, the summary can be generated later. Furthermore, the generation unit can adjust the order of summary generation according to the submission timing of the document. As a result, by determining the priority of the summary based on the submission timing of the document, documents with imminent deadlines can be processed preferentially. Some or all of the above-described processing in the generation unit may be performed using a generative AI, or may be performed without using a generative AI. For example, the generation unit may input document submission timing data to a generative AI and have the generative AI determine the priority of the summary. Specifically, the generation unit inputs metadata such as submission deadlines assigned to each uploaded document (e.g., ISO8601 date string), creation date, and project progress status as input features to the AI model. Examples of input include {“filename”: “urgent_report. pdf”, “deadline”: “2024 Jun. 10”} or {“filename”: “reference. pdf”, “deadline”: “2024 Jul. 1”}. The AI model scores the priority of summary generation in order of nearest submission deadline and outputs a prioritized list. Output examples include {“summary_order”: [“urgent_report.pdf”, “reference.pdf”]}. These outputs are reflected in the summary generation queue and user interface, presenting progress and priority to the user. When not using AI, rule-based processing simply sorts by ascending submission deadline. Internally, the AI model uses deadline embedding and attention mechanisms to dynamically adjust the priority of multiple documents. As a result, the generation unit achieves summary generation tailored to business deadline management and task priority, preventing deadline delays, improving work efficiency, and reducing user burden. Application fields include corporate workflow management, academic paper submission support, progress management for administrative procedures, and assignment submission support in educational settings.

The generation unit can adjust the order of the summary based on the relevance of the document at the time of summary generation. The generation unit adjusts the order of the summary based on the relevance of the document at the time of summary generation. For example, for highly relevant documents, the summary is generated preferentially. For documents with low relevance, the summary can be generated later. Furthermore, the generation unit can adjust the order of summary generation according to the relevance of the document. As a result, by adjusting the order of the summary based on the relevance of the document, highly relevant documents can be processed preferentially. Some or all of the above-described processing in the generation unit may be performed using a generative AI, or may be performed without using a generative AI. For example, the generation unit may input document relevance data to a generative AI and have the generative AI adjust the order of the summary. Specifically, the generation unit inputs relevance scores between multiple documents (e.g., continuous values from 0.0 to 1.0, number of matching tags, content similarity), project relevance, and past usage history as metadata to the AI model. Examples of input include {“files”: [{“filename”: “projectA_report.pdf”, “tags”: [“AI”, “NLP”]}, {“filename”: “projectA_slide.pptx”, “tags”: [“AI”, “NLP”]}, {“filename”: “projectB_report.pdf”, “tags”: [“IoT”]}]}. The AI model groups documents with high relevance and optimizes the order of summary generation for output. Output examples include {“summary_order”: [“projectA_report.pdf”, “projectA_slide.pptx”, “projectB_report.pdf”]}. These outputs are reflected in the summary generation queue and user interface, presenting clusters of related documents to the user. When not using AI, rule-based processing is performed based on the number of matching tags or content similarity. Internally, the AI model calculates vector embeddings between documents and quantitatively evaluates relevance using cosine similarity or clustering methods. As a result, the generation unit achieves summary generation tailored to the context of business or projects, preventing information omissions, improving work efficiency, and enhancing user satisfaction. Application fields include project management systems, research and development support tools, educational material management, and grouping of administrative documents.

The display unit can estimate a user's emotion and adjust the method of displaying the summary based on the estimated emotion. The display unit estimates the user's emotion and adjusts the summary display method according to the estimated emotion. For example, if the user is nervous, a simple and highly visible display method is provided. If the user is relaxed, a display method including detailed information can be provided. Furthermore, if the user is in a hurry, a display method that emphasizes key points can be provided. By adjusting the summary display method based on the user's emotion, a display method suitable for the user can be provided. Emotion estimation is realized, for example, by using an emotion engine or emotion estimation function with generative AI. Generative AI may include, for example, text generation AI (such as LLM) or multimodal generative AI, but is not limited to these examples. Some or all of the above-described processing in the display unit may be performed using AI or without using AI. For example, the display unit may input the user's emotion data to generative AI and have the generative AI execute the adjustment of the summary display method. Specifically, the display unit inputs user emotion estimation data (e.g., mouse movement speed, click frequency, input text content, biometric information, etc.) to an emotion classification AI model (e.g., multimodal Transformer architecture) to estimate emotion labels (e.g., nervous, relaxed, in a hurry, etc.). Examples of input include {“mouse_speed”: 90, “click_rate”: 2.1, “text_sample”: “I'm in a hurry”} or {“mouse_speed”: 30, “click_rate”: 0.5, “text_sample”: “Working calmly”}. The display unit inputs the estimated emotion label as a prompt to a large language model and conditionally generates the summary display method (e.g., simple display, detailed display, key point emphasis display, etc.). Examples of output include simple display (e.g., displaying only key points in large font), detailed display (e.g., expanding summary text +supplementary information +related links), and key point emphasis display (e.g., highlighting important terms with color coding). These outputs are passed to the web frontend rendering engine and reflected in the actual UI display. Within the AI model, emotion embeddings are used to control the selection of UI components and layout parameters (e.g., font size, amount of information, color design). If AI is not used, the display method is switched based on rule-based processing according to the emotion label. Furthermore, the display unit can provide an individually optimized display experience by considering the user's past emotion estimation history and display preferences. As a result, the display unit realizes flexible summary display tailored to the user's psychological state and work situation, and achieves technical effects such as optimization of information transmission, improvement of work efficiency, and enhancement of user satisfaction. Application fields include business chat tools, learning support platforms, patient explanation document display in medical settings, and administrative document viewing systems.

The display unit can refer to the user's past operation history when displaying a summary and select the optimal display method. The display unit refers to the user's past operation history when displaying a summary and selects the optimal display method. For example, the display unit preferentially provides display methods that the user has preferred in the past. It can also propose optimal display methods based on the user's past operation history. Furthermore, customized display methods can be provided based on the user's operation history. By referring to the user's past operation history, the optimal display method can be provided. Some or all of the above-described processing in the display unit may be performed using AI or without using AI. For example, the display unit may input the user's operation history data to AI and have the AI select the optimal display method. Specifically, the display unit maintains an operation history database for each user (e.g., history of display format selection over the past 30 days, display time, number of interactions, device type, etc.), and inputs these history data as time-series vectors or categorical features to the AI model. Examples of input include {“history”: [{“date”: “2024 Jun. 1”, “display_type”: “card”, “device”: “smartphone”}, {“date”: “2024 Jun. 2”, “display_type”: “text”, “device”: “desktop”}], “current_device”: “tablet”}. The AI model learns the user's display preferences and usage tendencies from these histories and outputs the optimal display method (e.g., card type, text type, detailed expansion type, etc.) for the current situation (e.g., device type, time of day, document type). Examples of output include {“recommended_display”: “card”} or {“recommended_display”: “text”}. These outputs are reflected in the UI rendering engine of the web frontend and presented to the user as recommended display methods. If AI is not used, the method is determined by simple frequency aggregation or rule-based processing. Within the AI model, time-series history embeddings and attention mechanisms are used to dynamically predict user display preferences. Furthermore, if the user manually changes the display method, the feedback is immediately reflected in the history database and utilized for selecting the display method in subsequent sessions. As a result, the display unit realizes a personalized summary display experience tailored to each user's operation habits and usage situation, and achieves technical effects such as improved visibility and operability, reduced erroneous operations, and enhanced system usability. Application fields include business chat tools, learning support platforms, administrative document viewing systems, and patient explanation document display in medical settings.

The display unit can adjust the display priority based on the importance of the document when displaying a summary. The display unit adjusts the display priority based on the importance of the document when displaying a summary. For example, the summary of documents with high importance is displayed preferentially. The summary of documents with low importance can be displayed later. Furthermore, the display order of summaries can be adjusted according to the importance of the document. By adjusting the display priority based on the importance of the document, important documents can be displayed preferentially. Some or all of the above-described processing in the display unit may be performed using AI or without using AI. For example, the display unit may input document importance data to AI and have the AI adjust the display priority. Specifically, the display unit inputs metadata such as importance scores assigned to each document (e.g., continuous values from 0.0 to 1.0 or categorical values such as “high,” “medium,” “low”), submission deadlines, and project relevance as input features to the AI model. Examples of input include {“filename”: “urgent_report. pdf”, “importance”: 0.95} or {“filename”: “reference.pdf”, “importance”: 0.3}. The AI model automatically adjusts the summary display order according to the importance score and outputs a prioritized list. Examples of output include {“display_order”: [“urgent_report.pdf”, “reference.pdf”]}. These outputs are reflected in the summary display queue or user interface and presented to the user as progress status or priority. If AI is not used, rule-based processing is performed by simply sorting in descending order of importance score. Within the AI model, importance embeddings and attention mechanisms are used to dynamically adjust the display priority of multiple documents. Furthermore, the display unit can provide an individually optimized display experience by considering the user's past display history and work situation. As a result, the display unit realizes flexible summary display tailored to business priorities and urgency, and achieves technical effects such as prevention of deadline delays, improvement of work efficiency, and reduction of user burden. Application fields include corporate workflow management, academic paper review, key point extraction from administrative documents, and educational material summarization.

The display unit can estimate a user's emotion and adjust the order of summary display based on the estimated emotion. The display unit estimates the user's emotion and adjusts the order of summary display according to the estimated emotion. For example, if the user is nervous, important summaries are displayed first. If the user is relaxed, all summaries can be displayed evenly. Furthermore, if the user is in a hurry, the most important summary can be displayed with the highest priority. By adjusting the order of summary display based on the user's emotion, summaries can be displayed in an order suitable for the user. Emotion estimation is realized, for example, by using an emotion engine or emotion estimation function with generative AI. Generative AI may include, for example, text generation AI (such as LLM) or multimodal generative AI, but is not limited to these examples. Some or all of the above-described processing in the display unit may be performed using AI or without using AI. For example, the display unit may input the user's emotion data to generative AI and have the generative AI execute the adjustment of the summary display order. Specifically, the display unit inputs user emotion estimation data (e.g., mouse movement speed, click frequency, input text content, biometric information, etc.) to an emotion classification AI model (e.g., multimodal Transformer architecture) to estimate emotion labels (e.g., nervous, relaxed, in a hurry, etc.). Examples of input include {“mouse_speed”: 120, “click_rate”: 3.0, “text_sample”: “I'm in a hurry”} or {“mouse_speed”: 40, “click_rate”: 0.7, “text_sample”: “Working calmly”}. The AI model combines the estimated emotion label with document importance data to output the order of summary display (e.g., prioritized list). Examples of output include {“display_order”: [“urgent_report.pdf”, “reference.pdf”]} or {“display_order”: [“reference.pdf”, “urgent_report.pdf”]}. These outputs are reflected in the summary display queue or user interface and presented to the user in the optimal order. If AI is not used, the order is determined by rule-based processing based on emotional state and importance. Within the AI model, emotion embeddings and importance embeddings are integrated, and attention mechanisms or clustering methods are used to optimize the display order. Furthermore, the display unit can provide an individually optimized display experience by considering the user's past emotion estimation history and display preferences. As a result, the display unit realizes flexible summary display control that balances the user's psychological state and business priorities, and achieves technical effects such as rapid presentation of important documents, reduction of user burden, and optimization of work efficiency. Application fields include corporate workflow management, support for assignment presentation in educational settings, and prioritized patient explanation document display in medical settings.

The display unit can select the optimal display method by considering the user's device information when displaying a summary. The display unit selects the optimal display method by considering the user's device information when displaying a summary. For example, if the user is using a smartphone, a display method tailored to the screen size is provided. If the user is using a tablet, a display method optimized for a large screen can be provided. Furthermore, if the user is using a smartwatch, a concise and highly visible display method can be provided. By considering the user's device information, the optimal display method can be provided. Some or all of the above-described processing in the display unit may be performed using AI or without using AI. For example, the display unit may input the user's device information to AI and have the AI select the optimal display method. Specifically, the display unit inputs device information obtained from the user terminal (e.g., screen resolution, OS type, browser type, input method, battery level, etc.) as input features to the AI model. Examples of input include {“device”: “smartphone”, “screen_size”: “360×740”, “os”: “Android”}, {“device”: “tablet”, “screen_size”: “1200×1920”, “os”: “iOS”}, or {“device”: “smartwatch”, “screen_size”: “200×200”, “os”: “WearOS”}. The AI model outputs the optimal display method (e.g., simple text, card type, detailed expansion type, icon emphasis type, etc.) and layout parameters (e.g., font size, amount of information, button arrangement) from these inputs. Examples of output include {“display_type”: “card”, “font_size”: 18} or {“display_type”: “simple”, “font_size”: 14}. These outputs are passed to the web frontend rendering engine and reflected in the actual UI display. If AI is not used, the display method is switched based on rule-based processing according to device type or screen size. Within the AI model, device embeddings and attention mechanisms are used to dynamically adjust parameters for optimizing the user experience. Furthermore, the display unit can provide an individually optimized display experience by considering the user's past device usage history and display preferences. As a result, the display unit realizes optimal summary display according to the user's usage environment and work purpose, and achieves technical effects such as improved visibility and operability, optimization of information transmission, and enhancement of user satisfaction. Application fields include business chat tools, learning support platforms, patient explanation document display in medical settings, and administrative document viewing systems.

The display unit can prioritize the display of highly relevant summaries by considering the user's geographic location information when displaying a summary. The display unit prioritizes the display of highly relevant summaries by considering the user's geographic location information when displaying a summary. For example, if the user is in a specific region, summaries related to that region are displayed preferentially. If the user is traveling, summaries related to the travel destination can be displayed preferentially. Furthermore, if the user is at home, summaries related to the household can be displayed preferentially. By considering the user's geographic location information, highly relevant summaries can be displayed preferentially. Some or all of the above-described processing in the display unit may be performed using AI or without using AI. For example, the display unit may input the user's geographic location information to AI and have the AI select highly relevant summaries. Specifically, the display unit combines multiple geographic features obtained from the user terminal, such as latitude/longitude information, region estimation results based on IP address, Wi-Fi access point information, and mobile base station ID, to accurately determine the user's current location. The display unit simultaneously collects metadata of summary candidates (e.g., document name, creation location, related region tags, content samples), vectorizes this information, and inputs it to the AI model. Examples of input include {“location”: “35.6895,139.6917”, “summary_candidates”: [{“filename”: “Tokyo_meeting.pdf”, “tags”: [“Tokyo”, “2024”]}, {“filename”: “Osaka_report.pdf”, “tags”: [“Osaka”, “2023”]}]} or {“location”: “Kyoto”, “summary_candidates”: [{“filename”: “Kyoto_event.docx”, “tags”: [“Kyoto”, “event”]}]}. The AI model calculates the relevance score between each summary and the current location from these inputs and outputs summaries above a predetermined threshold as prioritized display candidates. Examples of output include {“selected_summaries”: [“Tokyo_meeting.pdf”]} or {“selected_summaries”: [“Kyoto_event. docx”]}. These outputs are reflected in the summary display UI and presented to the user as recommended summaries. If AI is not used, relevance is determined by matching place name tags or rule-based processing. Within the AI model, geographic features and summary metadata are embedded in a high-dimensional space, and cosine similarity or attention mechanisms are used to quantitatively evaluate relevance. Furthermore, the display unit can automatically prioritize the display of summaries related to the destination during travel or business trips by considering the user's movement history and past display tendencies. As a result, the display unit realizes summary display tailored to the user's current location and movement status, and achieves technical effects such as prevention of unnecessary information mixing, improvement of work efficiency, and optimization of information management. Application fields include on-site business support systems, region-limited event document management, automatic organization of business trip reports, regional teaching material distribution in educational settings, and sharing of local information during disasters.

The editing unit can estimate a user's emotion and adjust the method of displaying the editing screen based on the estimated emotion. The editing unit estimates the user's emotion and adjusts the editing screen display method according to the estimated emotion. For example, if the user is nervous, an interface with calm colors is provided to reduce visual stress. If the user is enjoying the work, an interface with bright colors is provided to make the input work enjoyable. Furthermore, if the user is tired, a simple and highly visible interface is provided to make input work easier. By adjusting the editing screen display method based on the user's emotion, a display method suitable for the user can be provided. Emotion estimation is realized, for example, by using an emotion engine or emotion estimation function with generative AI. Generative AI may include, for example, text generation AI (such as LLM) or multimodal generative AI, but is not limited to these examples. Some or all of the above-described processing in the editing unit may be performed using AI or without using AI. For example, the editing unit may input the user's emotion data to generative AI and have the generative AI execute the adjustment of the editing screen display method. Specifically, the editing unit combines multiple data sources for user emotion estimation, such as mouse movement speed, click frequency, keyboard input speed, input text content (e.g., chat messages or comments), and biometric information obtained from wearable devices (e.g., heart rate, skin conductance, facial images), to generate a multidimensional input vector for emotion estimation. The editing unit inputs these data to an emotion classification AI model using a multimodal Transformer architecture to estimate emotion labels (e.g., nervous, enjoyment, fatigue, relaxation, concentration, etc.). Examples of input include {“mouse_speed”: 40, “click_rate”: 0.7, “heart_rate”: 105, “text_sample”: “I'm nervous”} or {“mouse_speed”: 120, “click_rate”: 3.5, “heart_rate”: 80, “text_sample”: “I'm having fun”}. The AI model embeds the estimated emotion label and inputs it as a prompt to a large language model or UI optimization model to control display parameters such as UI theme, color scheme, font size, amount of information, and decorative elements (e.g., animation, icon display) of the editing screen. Examples of output include a calm color theme (e.g., background color #2E3A59, font color #F0F0F0, no animation), a bright color theme (e.g., background color #FFF9C4, accent color #FF9800, animation enabled), and a simple UI (e.g., minimal information, large buttons, expanded margins). These outputs are passed to the web-based editing screen rendering engine and reflected in the UI display in real time. If AI is not used, color schemes and UI configurations are switched based on rule-based processing according to the emotion label. Furthermore, the editing unit can provide an individually optimized display experience by considering the user's past emotion estimation history and display preferences. Within the AI model, emotion embeddings are used to dynamically adjust the selection of UI components and layout parameters, and attention mechanisms respond promptly to changes in the user's state. As a result, the editing unit realizes flexible editing screen display tailored to the user's psychological state and work situation, and achieves technical effects such as reduction of visual stress, improvement of work efficiency, and enhancement of user satisfaction. Application fields include business document editing, academic paper writing, educational material creation, record input in medical settings, and proofreading of administrative documents.

The editing unit can refer to the user's past editing history when displaying the editing screen and select the optimal display method. The editing unit refers to the user's past editing history when displaying the editing screen and selects the optimal display method. For example, the editing unit preferentially provides display methods that the user has preferred in the past. It can also propose optimal display methods based on the user's past editing history. Furthermore, customized display methods can be provided based on the user's editing history. By referring to the user's past editing history, the optimal display method can be provided. Some or all of the above-described processing in the editing unit may be performed using AI or without using AI. For example, the editing unit may input the user's editing history data to AI and have the AI select the optimal display method. Specifically, the editing unit maintains an editing history database for each user (e.g., history of editing screen layout selection over the past 30 days, display theme, number of times editing tools were used, editing time, device type, type of editing content, etc.), and inputs these history data as time-series vectors or categorical features to the AI model. Examples of input include {“history”: [{“date”: “2024 Jun. 1”, “display_theme”: “dark”, “tool”: “slide”, “device”: “desktop”}, {“date”: “2024 Jun. 2”, “display_theme”: “light”, “tool”: “report”, “device”: “tablet”}], “current_device”: “desktop”}. The AI model learns the user's display preferences and usage tendencies from these histories and outputs the optimal display method (e.g., dark theme, light theme, toolbar arrangement, amount of information, multi-window layout, etc.) for the current situation (e.g., device type, time of day, document type). Examples of output include {“recommended_theme”: “dark”, “layout”: “multi_window”} or {“recommended_theme”: “light”, “layout”: “single_window”}. These outputs are reflected in the UI rendering engine of the editing screen and presented to the user as recommended display methods. If AI is not used, the method is determined by simple frequency aggregation or rule-based processing. Within the AI model, time-series history embeddings and attention mechanisms are used to dynamically predict user display preferences and respond to changes in history patterns. Furthermore, if the user manually changes the display method, the feedback is immediately reflected in the history database and utilized for selecting the display method in subsequent sessions. As a result, the editing unit realizes a personalized editing screen display experience tailored to each user's operation habits and usage situation, and achieves technical effects such as improved visibility and operability, reduced erroneous operations, and enhanced system usability. Application fields include business document editing, academic paper writing, educational material creation, program specification creation, and record input in medical settings.

The editing unit can provide different editing tools according to the category of the document when displaying the editing screen. The editing unit provides different editing tools according to the category of the document when displaying the editing screen. For example, for meeting minutes, tools for summarizing key points by agenda are provided. For research papers, citation management tools and reference list creation tools can be provided. Furthermore, for presentations, slide design tools and animation creation tools can be provided. By providing different editing tools according to the category of the document, editing suitable for each category becomes possible. Some or all of the above-described processing in the editing unit may be performed using AI or without using AI. For example, the editing unit may input document category data to AI and have the AI select the optimal editing tools. Specifically, the editing unit inputs category information assigned to each document (e.g., “meeting minutes,” “research paper,” “presentation,” “news article,” etc.), content samples, tag information, editing history, and the user's past tool usage tendencies as input features to the AI model. Examples of input include {“category”: “meeting minutes”, “text_sample”: “Attendees of the meeting on Jun. 1, 2024 . . . ”} or {“category”: “research paper”, “text_sample”: “This study . . . ”}. The AI model automatically selects an optimized set of editing tools for each category (e.g., agenda split editor, key point extraction assistant, citation management, automatic reference generation, slide design templates, animation editor, etc.) and dynamically incorporates them into the user's editing screen. Examples of output include {“tools”: [“agenda split editor”, “key point extraction assistant”]} or {“tools”: [“citation management”, “reference list creation”]}. These outputs are reflected in the toolbar or sidebar of the editing screen and presented to the user as recommended tools. If AI is not used, rule-based processing is performed to switch tool sets designed for each category. Within the AI model, category embeddings and conditional branching are used to dynamically adjust tool selection logic and UI configuration. Furthermore, the editing unit can provide an individually optimized tool set by considering the user's past editing history and usage tendencies. As a result, the editing unit realizes optimal editing tool provision tailored to the information structure and editing purpose of each document type, and achieves technical effects such as improved editing efficiency, reduced work burden, and enhanced user satisfaction. Application fields include corporate meeting document creation, academic paper writing, educational material editing, administrative document proofreading, and program specification creation.

The editing unit can estimate a user's emotion and adjust the operation procedure of the editing screen based on the estimated emotion. The editing unit estimates the user's emotion and adjusts the operation procedure of the editing screen according to the estimated emotion. For example, if the user is nervous, the operation procedure is simplified to allow intuitive operation. If the user is relaxed, detailed operation procedures are provided and customizable options can be increased. Furthermore, if the user is in a hurry, the shortest operation procedure is proposed to enable rapid progress. By adjusting the operation procedure of the editing screen based on the user's emotion, an operation procedure suitable for the user can be provided. Emotion estimation is realized, for example, by using an emotion engine or emotion estimation function with generative AI. Generative AI may include, for example, text generation AI (such as LLM) or multimodal generative AI, but is not limited to these examples. Some or all of the above-described processing in the editing unit may be performed using AI or without using AI. For example, the editing unit may input the user's emotion data to generative AI and have the generative AI execute the adjustment of the operation procedure. Specifically, the editing unit inputs user emotion estimation data (e.g., mouse movement speed, click frequency, input text content, biometric information, etc.) to an emotion classification AI model (e.g., multimodal Transformer) to estimate emotion labels (e.g., nervous, relaxed, in a hurry, etc.). Examples of input include {“mouse_speed”: 30, “click_rate”: 0.5, “heart_rate”: 110, “text_sample”: “I'm nervous”} or {“mouse_speed”: 120, “click_rate”: 3.0, “heart_rate”: 80, “text_sample”: “I'm relaxed”}. The AI model inputs the estimated emotion label as a prompt to a large language model or UI optimization model and conditionally generates the complexity of the operation procedure (e.g., number of steps, number of options, presence of guide display) and navigation method (e.g., wizard format, quick action, detailed settings mode, etc.). Examples of output include simplified procedure (e.g., 3-step wizard, display only main buttons), detailed procedure (e.g., expand all options, customizable), and shortest procedure (e.g., one-click execution, shortcut key suggestion). These outputs are reflected in the UI rendering engine of the editing screen and presented to the user as the optimal operation procedure. If AI is not used, rule-based processing is performed to switch procedure configuration according to the emotion label. Within the AI model, emotion embeddings are used to dynamically adjust operation procedure control parameters and respond promptly to changes in the user's state. Furthermore, the editing unit can provide an individually optimized operation experience by considering the user's past operation history and preferences. As a result, the editing unit realizes flexible operation procedure control tailored to the user's psychological state and work situation, and achieves technical effects such as improved work efficiency, reduced erroneous operations, and enhanced user satisfaction. Application fields include business document editing, academic paper writing, educational material creation, record input in medical settings, and proofreading of administrative documents.

The editing unit can select the optimal display method by considering the user's device information when displaying the editing screen. The editing unit selects the optimal display method by considering the user's device information when displaying the editing screen. For example, if the user is using a smartphone, a display method tailored to the screen size is provided. If the user is using a tablet, a display method optimized for a large screen can be provided. Furthermore, if the user is using a desktop, a layout that allows multiple windows to be displayed simultaneously can be provided. By considering the user's device information, the optimal display method can be provided. Some or all of the above-described processing in the editing unit may be performed using AI or without using AI. For example, the editing unit may input the user's device information to AI and have the AI select the optimal display method. Specifically, the editing unit inputs device information obtained from the user terminal (e.g., screen resolution, OS type, browser type, input method, battery level, network speed, etc.) as input features to the AI model. Examples of input include {“device”: “smartphone”, “screen_size”: “360×740”, “os”: “Android”}, {“device”: “tablet”, “screen_size”: “1200×1920”, “os”: “iOS”}, or {“device”: “desktop”, “screen_size”: “1920×1080”, “os”: “Windows”}. The AI model outputs the optimal display method (e.g., simple text, card type, detailed expansion type, multi-window type, etc.) and layout parameters (e.g., font size, amount of information, button arrangement, number of window splits) from these inputs. Examples of output include {“display_type”: “card”, “font_size”: 18, “window_layout”: “single”} or {“display_type”: “multi_window”, “font_size”: 16, “window_layout”: “split”}. These outputs are passed to the rendering engine of the editing screen and reflected in the actual UI display. If AI is not used, the display method is switched based on rule-based processing according to device type or screen size. Within the AI model, device embeddings and attention mechanisms are used to dynamically adjust parameters for optimizing the user experience. Furthermore, the editing unit can provide an individually optimized display experience by considering the user's past device usage history and display preferences. As a result, the editing unit realizes optimal editing screen display according to the user's usage environment and work purpose, and achieves technical effects such as improved visibility and operability, optimization of information transmission, and enhancement of user satisfaction. Application fields include business document editing, academic paper writing, educational material creation, program specification creation, and record input in medical settings.

The editing unit can provide highly relevant editing tools by considering the user's geographic location information when displaying the editing screen. The editing unit provides highly relevant editing tools by considering the user's geographic location information when displaying the editing screen. For example, if the user is in a specific region, templates or tools related to that region are provided. If the user is traveling, tools for editing information related to the travel destination can be provided. Furthermore, if the user is at home, tools for editing household-related documents can be provided. By considering the user's geographic location information, highly relevant editing tools can be provided. Some or all of the above-described processing in the editing unit may be performed using AI or without using AI. For example, the editing unit may input the user's geographic location information to AI and have the AI select highly relevant editing tools. Specifically, the editing unit combines multiple geographic features obtained from the user terminal, such as latitude/longitude information, region estimation results based on IP address, Wi-Fi access point information, and mobile base station ID, to accurately determine the user's current location. The editing unit simultaneously collects metadata of candidate documents for editing (e.g., file name, creation location, related region tags, content samples), region-limited templates, and region-specific editing tools (e.g., document templates for local governments, slide designs for local events), vectorizes this information, and inputs it to the AI model. Examples of input include {“location”: “35.6895,139.6917”, “tool_candidates”: [{“tool”: “Tokyo_template”, “tags”: [“Tokyo”, “2024”]}, {“tool”: “Osaka_template”, “tags”: [“Osaka”, “2023”]}]} or {“location”: “Kyoto”, “tool_candidates”: [{“tool”: “Kyoto_event_editor”, “tags”: [“Kyoto”, “event”]}]}. The AI model calculates the relevance score between each editing tool and the current location from these inputs and outputs tools above a predetermined threshold as prioritized candidates. Examples of output include {“selected_tools”: [“Tokyo_template”]} or {“selected_tools”: [“Kyoto_event_editor”]}. These outputs are reflected in the toolbar or sidebar of the editing screen and presented to the user as recommended tools. If AI is not used, relevance is determined by matching place name tags or rule-based processing. Within the AI model, geographic features and tool metadata are embedded in a high-dimensional space, and cosine similarity or attention mechanisms are used to quantitatively evaluate relevance. Furthermore, the editing unit can automatically prioritize the display of editing tools related to the destination during travel or business trips by considering the user's movement history and past editing tendencies. As a result, the editing unit realizes editing tool provision tailored to the user's current location and movement status, and achieves technical effects such as prevention of unnecessary tool mixing, improvement of work efficiency, and optimization of information management. Application fields include on-site business support systems, region-limited event document editing, automatic organization of business trip reports, regional teaching material creation in educational settings, and sharing of local information during disasters.

The system according to the embodiment is not limited to the examples described above and can be variously modified as follows, for example. Specifically, the system can flexibly expand or modify the functions and cooperation methods of each component, such as the receiving unit, generation unit, display unit, and editing unit, according to user requirements and operating environments. The system can change the type of AI model (e.g., large language model, image recognition model, multimodal model, etc.), version of trained parameters, implementation method of inference engine (e.g., GPU cluster, edge device, cloud API, etc.), database structure (e.g., NoSQL, relational, graph DB, etc.), and user interface design (e.g., web application, mobile application, desktop application, etc.). Furthermore, the system can realize various technical variations, such as adding upload methods in the receiving unit (e.g., voice input, QR code reading, automatic acquisition of email attachments, etc.), switching summary generation algorithms in the generation unit (e.g., extractive summarization, generative summarization, template-based summarization, etc.), multi-device support in the display unit (e.g., smartwatch, AR glasses, etc.), and adding collaborative editing functions or version management functions in the editing unit. When using AI, the system can flexibly select the type of input data, preprocessing methods (e.g., normalization, tokenization, image resizing, etc.), AI model architecture (e.g., Transformer, CNN, RNN, etc.), learning methods (e.g., supervised learning, transfer learning, self-supervised learning, etc.), and output formats (e.g., probability distribution, label, score, structured data, etc.). When not using AI, rule-based processing, threshold judgment, and user-defined custom logic can be combined for implementation. As a result, the system realizes an information processing flow optimized for specific business requirements and operating environments, and achieves technical effects such as improved system scalability, maintainability, operational efficiency, optimization of user experience, and reduction of introduction costs. Application fields include corporate document management, educational material distribution in educational settings, record management in medical settings, digitization of administrative procedures, research and development support, event management, and information sharing during disasters.

The receiving unit can propose the optimal upload method according to the type of document uploaded by the user. For example, when the user uploads meeting minutes, drag-and-drop is recommended, and when uploading a research paper, a file selection dialog can be recommended. Furthermore, the receiving unit can analyze the user's past upload history and preferentially propose the most frequently used upload method. Additionally, the optimal upload method can be automatically selected according to the size and format of the document uploaded by the user. As a result, the user can efficiently upload documents and reduce the effort required for the task. Specifically, the receiving unit analyzes the metadata of the document to be uploaded by the user in real time (e.g., file extension, file size, creation date, document category) and dynamically presents an upload UI optimized for each document type (e.g., drag-and-drop area, file selection dialog, URL input field, voice input button, etc.). The receiving unit maintains an upload history database for each user (e.g., upload method over the past 30 days, document type, success/failure flag, device used, etc.), and inputs these histories as time-series vectors or categorical features to the AI model. Examples of input include {“history”: [{“date”: “2024 Jun. 1”, “method”: “drag_drop”, “file_type”: “pdf”}, {“date”: “2024 Jun. 2”, “method”: “dialog”, “file_type”: “docx”}], “current_file_type”: “pdf”, “file_size”: 2.5}. The AI model integrally analyzes multiple features such as document type, file size, past usage tendencies, and device type, and outputs the optimal upload method (e.g., drag-and-drop, file selection dialog, URL input, automatic acquisition of email attachments, etc.). Examples of output include {“recommended_method”: “drag_drop”} or {“recommended_method”: “dialog”}. These outputs are reflected in the UI of the receiving unit and presented to the user as recommended methods. If AI is not used, the method is determined by rule-based processing according to document type or file size. Within the AI model, document type embeddings, history embeddings, and attention mechanisms are used to realize method selection tailored to each user's operation habits and document characteristics. As a result, the receiving unit realizes a personalized upload experience according to document type, size, format, and user tendencies, and achieves technical effects such as improved operation efficiency, reduced erroneous operations, and enhanced system usability. Application fields include corporate document management systems, academic paper submission platforms, electronic application systems for administrative procedures, and assignment submission support in educational settings.

The generation unit can automatically adjust the format of the summary based on the content of the document. For example, for meeting minutes, a bullet-point summary organized by agenda items can be generated. For research papers, a paragraph-format summary extracting the main conclusions and findings can be generated. Furthermore, for news articles, a summary format including important events and background information can also be generated. As a result, the optimal summary format can be provided according to the type of document, allowing users to efficiently grasp information. Specifically, the generation unit inputs the text data and metadata of the uploaded document (e.g., category, tags, creation date, author information, etc.) as input features to the AI model. Examples of input include {“category”: “meeting minutes”, “text_sample”: “Attendees of the meeting on Jun. 1, 2024 . . . ”}, {“category”: “research paper”, “text_sample”: “This study . . . ”}, or {“category”: “news article”, “text_sample”: “On Jun. 1, 2024, a new product launch event was held in major cities . . . ”}. The AI model uses category embeddings and content embeddings to automatically select the optimal summary generation algorithm for each category (e.g., agenda split +key point extraction, conclusion extraction +background summarization, event extraction +chronological organization, etc.), and combines large language models and rule-based extractors to generate the summary. Examples of output include summary for meeting minutes (e.g., “Agenda 1: New product progress, Agenda 2: Budget approval”), summary for papers (e.g., “This paper proposes a novel CNN architecture and reports improved accuracy on ImageNet.”), and summary for news articles (e.g., “On Jun. 1, 2024, a new product launch event was held in major cities.”). These outputs are transferred to subsequent display units or editing units to support users in document creation and information comprehension. If AI is not used, rule-based extractors designed for each category are applied. Within the AI model, category embeddings and conditional branching are used to switch attention mechanisms, extraction rules, and generation templates. As a result, the generation unit realizes optimal summary generation tailored to the information structure and usage purpose of each document type, and achieves technical effects such as improved accuracy of information transmission, improved work efficiency, and enhanced user satisfaction. Application fields include corporate meeting document creation, academic paper review, news summarization in media organizations, and educational material summarization in educational settings.

The display unit can select the optimal display format based on the user's device information. For example, if the user is using a smartphone, a simple display format tailored to the screen size can be provided. If the user is using a tablet, a detailed display format optimized for a large screen can be provided. Furthermore, if the user is using a desktop, a layout that allows multiple windows to be displayed simultaneously can also be provided. As a result, the optimal display format according to the user's device can be provided, allowing the user to comfortably check the summary. Specifically, the display unit inputs device information obtained from the user terminal (e.g., screen resolution, OS type, browser type, input method, battery level, etc.) as input features to the AI model. Examples of input include {“device”: “smartphone”, “screen_size”: “360×740”, “os”: “Android”}, {“device”: “tablet”, “screen_size”: “1200×1920”, “os”: “iOS”}, or {“device”: “desktop”, “screen_size”: “1920×1080”, “os”: “Windows”}. The AI model outputs the optimal display method (e.g., simple text, card type, detailed expansion type, multi-window type, etc.) and layout parameters (e.g., font size, amount of information, button arrangement, number of window splits) from these inputs. Examples of output include {“display_type”: “card”, “font_size”: 18, “window_layout”: “single”} or {“display_type”: “multi_window”, “font_size”: 16, “window_layout”: “split”}. These outputs are passed to the rendering engine of the display unit and reflected in the actual UI display. If AI is not used, the display method is switched based on rule-based processing according to device type or screen size. Within the AI model, device embeddings and attention mechanisms are used to dynamically adjust parameters for optimizing the user experience. Furthermore, the display unit can provide an individually optimized display experience by considering the user's past device usage history and display preferences. As a result, the display unit realizes optimal summary display according to the user's usage environment and work purpose, and achieves technical effects such as improved visibility and operability, optimization of information transmission, and enhancement of user satisfaction. Application fields include business chat tools, learning support platforms, patient explanation document display in medical settings, and administrative document viewing systems.

The editing unit can provide an AI-based auto-completion function to support the user's editing work. For example, when the user is creating slides for a presentation, AI can suggest appropriate slide designs and layouts. When the user is creating a report, AI can suggest appropriate sentence completions and addition of references. Furthermore, when the user is editing code, AI can perform code auto-completion and error checking. As a result, the user's editing work is streamlined and the work burden is reduced. Specifically, the editing unit inputs the content of the document being edited by the user (e.g., slide text, report text, code fragments), document category, past editing history, and template information in use as input features to the AI model. Examples of input include {“category”: “slide”, “current_text”: “Overview of AI technology . . . ”}, {“category”: “report”, “current_text”: “This study . . . ”}, or {“category”: “code”, “current_code”: “def func(”}. The AI model uses category embeddings, content embeddings, and history embeddings to automatically select the optimal completion algorithm for each category (e.g., slide design recommendation, automatic sentence generation, automatic reference insertion, code completion, syntax error detection, etc.), and dynamically presents completion candidates and correction suggestions in the user's editing screen. Examples of output include slide design candidates (e.g., “Title +body +image layout”), sentence completion (e.g., “The purpose of this study is . . . ”), reference candidates (e.g., “Smith et al., 2023”), code completion (e.g., “def func(x): return x*2”), and error indication (e.g., “SyntaxError: unexpected EOF”). These outputs are reflected in the suggestion field or auto-completion function of the editing screen and support the user's editing work in real time. If AI is not used, template-based or rule-based completion candidates are presented. Within the AI model, category embeddings, attention mechanisms, and token prediction algorithms are used to improve completion accuracy according to the user's input and editing history. Furthermore, the editing unit can provide an individually optimized completion experience by considering the user's past completion selection history and editing tendencies. As a result, the editing unit realizes flexible auto-completion functions tailored to document type and editing purpose, and achieves technical effects such as improved editing efficiency, reduced work burden, prevention of erroneous input, and enhancement of user satisfaction. Application fields include business document editing, academic paper writing, educational material creation, program specification creation, and record input in medical settings.

The display unit can estimate a user's emotion and adjust the method of displaying the summary based on the estimated emotion. For example, if the user is nervous, a simple and highly visible display method can be provided. If the user is relaxed, a display method including detailed information can be provided. Furthermore, if the user is in a hurry, a display method that emphasizes key points can also be provided. As a result, the optimal display method according to the user's emotion can be provided, allowing the user to comfortably check the summary. Specifically, the display unit inputs user emotion estimation data (e.g., mouse movement speed, click frequency, input text content, biometric information, etc.) to an emotion classification AI model (e.g., multimodal Transformer architecture) to estimate emotion labels (e.g., nervous, relaxed, in a hurry, etc.). Examples of input include {“mouse_speed”: 90, “click_rate”: 2.1, “text_sample”: “I'm in a hurry”} or {“mouse_speed”: 30, “click_rate”: 0.5, “text_sample”: “Working calmly”}. The display unit inputs the estimated emotion label as a prompt to a large language model and conditionally generates the summary display method (e.g., simple display, detailed display, key point emphasis display, etc.). Examples of output include simple display (e.g., displaying only key points in large font), detailed display (e.g., expanding summary text+supplementary information+related links), and key point emphasis display (e.g., highlighting important terms with color coding). These outputs are passed to the web frontend rendering engine and reflected in the actual UI display. Within the AI model, emotion embeddings are used to control the selection of UI components and layout parameters (e.g., font size, amount of information, color design). If AI is not used, the display method is switched based on rule-based processing according to the emotion label. Furthermore, the display unit can provide an individually optimized display experience by considering the user's past emotion estimation history and display preferences. As a result, the display unit realizes flexible summary display tailored to the user's psychological state and work situation, and achieves technical effects such as optimization of information transmission, improvement of work efficiency, and enhancement of user satisfaction. Application fields include business chat tools, learning support platforms, patient explanation document display in medical settings, and administrative document viewing systems.

The receiving unit can estimate a user's emotion and adjust the timing of uploading based on the estimated emotion. For example, if the user is feeling stressed, the timing of uploading can be delayed to provide time for relaxation. If the user is in a hurry, the timing of uploading can be accelerated to start processing quickly. Furthermore, if the user is focused, the timing of uploading can be adjusted to minimize interruption of work. By adjusting the timing of uploading based on the user's emotion, the user's work burden can be reduced. Specifically, the receiving unit combines multiple data sources such as user input interactions (e.g., mouse movement, click frequency, input speed), biometric information (e.g., heart rate from wearable devices, skin conductance), and text input content (e.g., chat messages, comments) to generate an input vector for emotion estimation. Examples of input include {“mouse_speed”: 120, “click_rate”: 3.2, “heart_rate”: 95, “text_sample”: “I'm in a hurry”} or {“mouse_speed”: 40, “click_rate”: 0.8, “heart_rate”: 65, “text_sample”: “Working calmly”}. The AI model uses these multidimensional inputs to output emotion classification (e.g., stress, relaxation, concentration, excitement, etc.) and further calculates the recommended upload timing (e.g., immediate, 5 minutes later, after user confirmation, etc.). Examples of output include {“emotion”: “stress”, “upload_timing”: “5 minutes later”} or {“emotion”: “in a hurry”, “upload_timing”: “immediate”}. These outputs are used in subsequent processing of the receiving unit (e.g., timing for enabling the upload button, notification display to the user). If AI is not used, timing is determined by threshold judgment or rule-based processing from input values. As a result, the receiving unit realizes flexible upload control according to the user's psychological state, and achieves technical effects such as minimization of work interruption, stress reduction, and optimization of user experience. Application fields include corporate stress management support systems, student support platforms in educational settings, and patient data input support in medical settings.

The generation unit can estimate a user's emotion and adjust the method of expressing the summary based on the estimated emotion. For example, if the user is relaxed, a detailed summary can be generated. If the user is in a hurry, a concise summary can be generated. Furthermore, if the user is excited, a visually attractive summary can also be generated. By adjusting the method of expressing the summary based on the user's emotion, a summary suitable for the user can be provided. Specifically, the generation unit inputs user emotion estimation data (e.g., input interactions, biometric information, text content) to an emotion classification AI model (e.g., multimodal Transformer) to estimate emotion labels (e.g., relaxation, in a hurry, excitement, etc.). Examples of input include {“mouse_speed”: 80, “heart_rate”: 70, “text_sample”: “Working calmly”} or {“mouse_speed”: 150, “heart_rate”: 110, “text_sample”: “I'm in a hurry”}. The AI model inputs the estimated emotion label and user request (e.g., summary format specification) as a prompt to a large language model and conditionally generates the method of expressing the summary (e.g., detailed explanation, concise summary, with visual effects, etc.). Examples of output include detailed summary (e.g., “This document describes in detail the overall picture of technology A, issues, solutions, and future prospects.”), concise summary (e.g., “Only the overview and main conclusions of technology A are described.”), and summary with visual effects (e.g., highlighting important terms, color coding, etc.). These outputs are transferred to subsequent display units or editing units to optimize the user experience. Within the AI model, emotion labels are embedded and used as parameters to control the length, style, and decorative elements of the generated text. If AI is not used, the method of expression is switched by threshold judgment or rule-based processing. As a result, the generation unit realizes flexible summary generation tailored to the user's psychological state, and achieves technical effects such as optimization of information transmission, improvement of work efficiency, and enhancement of user satisfaction. Application fields include business report creation, educational material summarization in educational settings, patient explanation document generation in medical settings, and personalized display of administrative documents.

The editing unit is capable of estimating a user's emotion and adjusting the display method of the editing screen based on the estimated emotion of the user. For example, if the user is nervous, a calm-colored interface can be provided to reduce visual stress. If the user is enjoying the task, a brightly colored interface can be provided to make the input work enjoyable. Furthermore, if the user is tired, a simple and highly visible interface can be provided to facilitate input work. By adjusting the display method of the editing screen based on the user's emotion, it is possible to provide a display method suitable for the user. Specifically, the editing unit generates a multidimensional input vector for emotion estimation by combining multiple data sources as emotion estimation data for the user, such as mouse movement speed, click frequency, keyboard input speed, input text content (e.g., chat messages or comments), and biometric information obtained from wearable devices (e.g., heart rate, skin conductance response, facial images). The editing unit inputs these data into an emotion classification AI model using a multimodal Transformer architecture to estimate emotion labels (e.g., nervousness, enjoyment, fatigue, relaxation, concentration, etc.). Examples of input include {“mouse_speed”: 40, “click_rate”: 0.7, “heart_rate”: 105, “text_sample”: “I am nervous”} and {“mouse_speed”: 120, “click_rate”: 3.5, “heart_rate”: 80, “text_sample”: “I am having fun”}. The AI model embeds the estimated emotion label and inputs it as a prompt to a large language model or UI optimization model to control display parameters such as UI theme, color scheme, font size, information volume, and decorative elements (e.g., animation, icon display) of the editing screen. Examples of output include a calm-colored theme (e.g., background color #2E3A59, font color #F0F0F0, no animation), a bright-colored theme (e.g., background color #FFF9C4, accent color #FF9800, animation enabled), and a simple UI (e.g., minimized information, enlarged buttons, expanded margins). These outputs are passed to a web-based editing screen rendering engine and reflected in the UI display in real time. If AI is not used, the color scheme and UI configuration are switched based on rule-based logic according to the emotion label. Furthermore, the editing unit can provide an individually optimized display experience by taking into account the user's past emotion estimation history and display preferences. Internally, the AI model dynamically adjusts the selection of UI components and layout parameters using emotion embedding and responds immediately to changes in the user's state via an attention mechanism. Thus, the editing unit realizes a flexible editing screen display tailored to the user's psychological state and work situation, achieving technical effects such as reduction of visual stress, improvement of work efficiency, and enhancement of user satisfaction. Applicable fields include business document editing, academic paper writing, educational material creation, record input in medical settings, and proofreading of administrative documents.

The editing unit is capable of estimating a user's emotion and adjusting the operation procedure of the editing screen based on the estimated emotion of the user. For example, if the user is nervous, the operation procedure can be simplified to allow intuitive operation. If the user is relaxed, detailed operation procedures can be provided, increasing customizable options. Furthermore, if the user is in a hurry, the shortest operation procedure can be suggested to enable rapid progress. By adjusting the operation procedure of the editing screen based on the user's emotion, it is possible to provide an operation procedure suitable for the user. Specifically, the editing unit inputs emotion estimation data for the user (e.g., mouse movement speed, click frequency, input text content, biometric information, etc.) into an emotion classification AI model (e.g., multimodal Transformer) to estimate emotion labels (e.g., nervousness, relaxation, being in a hurry, etc.). Examples of input include {“mouse_speed”: 30, “click_rate”: 0.5, “heart_rate”: 110, “text_sample”: “I am nervous”} and {“mouse_speed”: 120, “click_rate”: 3.0, “heart_rate”: 80, “text_sample”: “I am relaxed”}. The AI model inputs the estimated emotion label as a prompt to a large language model or UI optimization model, and conditionally generates the complexity of the operation procedure (e.g., number of steps, number of options, presence or absence of guide display) and navigation method (e.g., wizard format, quick action, detailed setting mode, etc.). Examples of output include simplified procedures (e.g., 3-step wizard, display of main buttons only), detailed procedures (e.g., all options expanded, customizable), and shortest procedures (e.g., one-click execution, shortcut key suggestion). These outputs are reflected in the UI rendering engine of the editing screen and presented to the user as the optimal operation procedure. If AI is not used, the procedure configuration is switched based on rule-based logic according to the emotion label. Internally, the AI model dynamically adjusts operation procedure control parameters using emotion embedding and responds immediately to changes in the user's state. Furthermore, the editing unit can provide an individually optimized operation experience by taking into account the user's past operation history and preferences. Thus, the editing unit realizes flexible operation procedure control tailored to the user's psychological state and work situation, achieving technical effects such as improved work efficiency, reduced operational errors, and enhanced user satisfaction. Applicable fields include business document editing, academic paper writing, educational material creation, record input in medical settings, and proofreading of administrative documents.

The receiving unit is capable of analyzing a user's past upload history and selecting an optimal upload method. For example, the upload method that the user has frequently used in the past (such as drag-and-drop or file selection) can be preferentially suggested. In addition, based on the user's past upload history, the optimal upload method for a specific time period can be proposed. Furthermore, the optimal upload method can be selected based on the type of files the user has uploaded in the past. By analyzing the user's past upload history, it is possible to provide the optimal upload method. Specifically, the receiving unit maintains an upload history database for each user (e.g., upload date and time for the past 30 days, file type, upload method, success/failure flag, etc.), and inputs these history data as time-series vectors or categorical features into an AI model. Examples of input include {“history”: [{“date”: “2024 Jun. 1”, “method”: “drag_drop”, “file_type”: “pdf”}, {“date”: “2024 Jun. 2”, “method”: “dialog”, “file_type”: “docx”}], “current_time”: “18:00”}. The AI model learns the user's tendencies from these histories and outputs the optimal upload method for the current situation (e.g., time period, file type), such as drag-and-drop, file selection dialog, or URL input. Examples of output include {“recommended_method”: “drag_drop”} and {“recommended_method”: “dialog”}. These outputs are reflected in the UI of the receiving unit and presented to the user as recommended methods. If AI is not used, the method is determined by simple frequency aggregation or rule-based logic. Internally, the AI model uses time-series history embedding and attention mechanisms to dynamically predict the user's display preferences. Furthermore, when the user manually changes the upload method, the receiving unit immediately reflects this feedback in the history database and utilizes it for method selection in subsequent sessions. Thus, the receiving unit realizes a personalized upload experience tailored to each user's operational habits and usage status, achieving technical effects such as improved operational efficiency, reduced operational errors, and enhanced system usability. Applicable fields include corporate document management systems, academic paper submission platforms, and electronic application systems for administrative procedures.

The following is a brief explanation of the processing flow of Example of the Embodiment. Specifically, the present system realizes a series of information processing flows from user document upload to summary generation, display, and editing by coordinating the respective modules of the receiving unit, generation unit, display unit, and editing unit. First, when receiving files or URLs (e.g., meeting minutes, research papers, website URLs, etc.) uploaded from the user's terminal, the receiving unit analyzes various features such as document type, file size, user's past history, emotional state, and device information, and dynamically selects the optimal upload method and timing. The receiving unit performs predetermined preprocessing (e.g., file format conversion, text extraction, metadata assignment, etc.) on the uploaded data and transfers it to the generation unit. Next, the generation unit inputs the content and metadata of the uploaded document, user requests, emotional state, etc. as input features to an AI model (e.g., large language model, multimodal model, etc.), and automatically generates the optimal summary format, expression method, length, and priority according to the document category, importance, submission deadline, etc. The generation unit outputs the summary generation result as structured data (e.g., bullet points, paragraphs, card format, etc.) and transfers it to the display unit. The display unit optimizes the summary display method (e.g., simple display, detailed display, key point emphasis display, multi-window, etc.) and display order by considering the user's device information, emotional state, past display history, etc., and reflects them in the UI of the web frontend or mobile app. The user checks the displayed summary and, if necessary, requests additional information or performs editing work. The editing unit analyzes the user's interactions during editing, emotional state, document category, past editing history, etc., and dynamically presents the optimal editing screen layout, operation procedure, completion functions, and tool set. The editing unit combines AI-based auto-completion, error checking, template recommendation, etc. to support the user's editing efficiency and reduce work burden. When using AI, multidimensional vectors and structured data are exchanged between modules, and technologies such as attention mechanisms, embedding, and history learning are utilized to realize personalized information processing. If AI is not used, processing is performed by combining rule-based logic, threshold determination, and user-defined logic. Thus, the present system realizes a flexible and efficient document management, summarization, and editing flow tailored to the user's work situation, psychological state, and usage environment, achieving technical effects such as optimization of information transmission, improvement of work efficiency, and enhancement of user satisfaction. Applicable fields include corporate workflow management, academic paper review, educational material summarization and editing, record management in medical settings, and digitization of administrative documents.

Step 1: The receiving unit allows the user to upload a PDF file or URL. The files or URLs uploaded by the user may include, for example, meeting minutes, research papers, website URLs, and so on. The receiving unit enables the user to easily upload files or URLs using drag-and-drop or a file selection dialog. Step 2: The generation unit uses generative AI to analyze the uploaded document and generate a summary in response to a request. The generative AI uses a text generation AI (for example, an LLM) to analyze the document, extract important points, and create a summary. The generation unit can also use generative AI to understand the content of the document and generate a summary in response to a request. For example, the generative AI extracts key topics and decisions from meeting minutes, and major conclusions and findings from research papers. Step 3: The display unit displays the summary generated by the generation unit on a chat screen. The chat screen can display the summary in text format or card format. In addition, the display unit can display the summary created by generative AI in a format that includes interactive elements. For example, the user can check the details of the summary or request additional information. Step 4: The editing unit provides an editing screen for the user to create a document based on the summary. The editing screen includes a text editor, slide creation tool, code editor, and so on. The editing unit enables the user to create presentation slides or reports based on the summary. Specifically, the present system analyzes metadata of the upload data, estimates user history and emotional state in the receiving unit, inputs summary generation parameters according to document category, importance, submission deadline, etc. into the AI model in the generation unit, determines the optimal display method and order considering device information, emotional state, and past display history in the display unit, and dynamically presents editing screen layout, completion functions, and tool set in the editing unit. Internally, the AI model utilizes embedding, attention mechanisms, history learning, token prediction algorithms, etc. at each step to realize personalized information processing for each user. If AI is not used, processing is performed by combining rule-based logic, threshold determination, and user-defined logic. Thus, the present system realizes a flexible and efficient document management, summarization, and editing flow tailored to the user's work situation, psychological state, and usage environment, achieving technical effects such as optimization of information transmission, improvement of work efficiency, and enhancement of user satisfaction. Applicable fields include corporate workflow management, academic paper review, educational material summarization and editing in educational settings, record management in medical settings, and digitization of administrative documents.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, generation unit, display unit, and editing unit is implemented by at least one of, for example, a smart device 14 and a data processing apparatus 12. For example, the receiving unit is implemented by a control unit 46A of the smart device 14, allowing a user to upload a PDF file or URL. The generation unit is implemented, for example, by a specific processing unit 290 of the data processing apparatus 12, and analyzes the uploaded document using generative AI to generate a summary in response to a request. The display unit is implemented, for example, by an output device 40 of the smart device 14, and displays the generated summary on a chat screen. The editing unit is implemented, for example, by the control unit 46A of the smart device 14, and provides an editing screen for the user to create a document based on the summary. The correspondence between each unit and the device or control unit is not limited to the examples described above and various modifications are possible.

### Second Embodiment

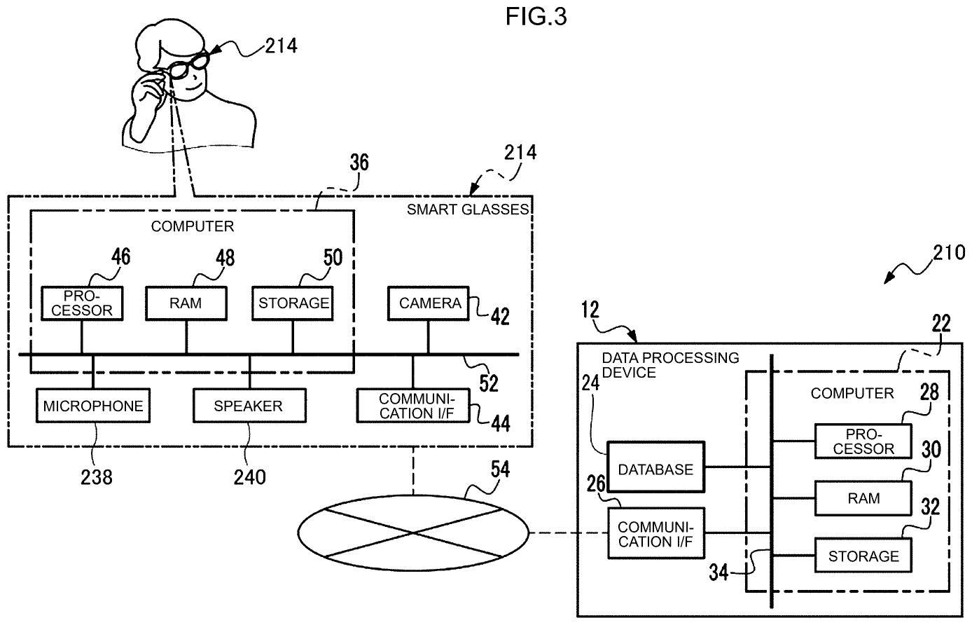

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

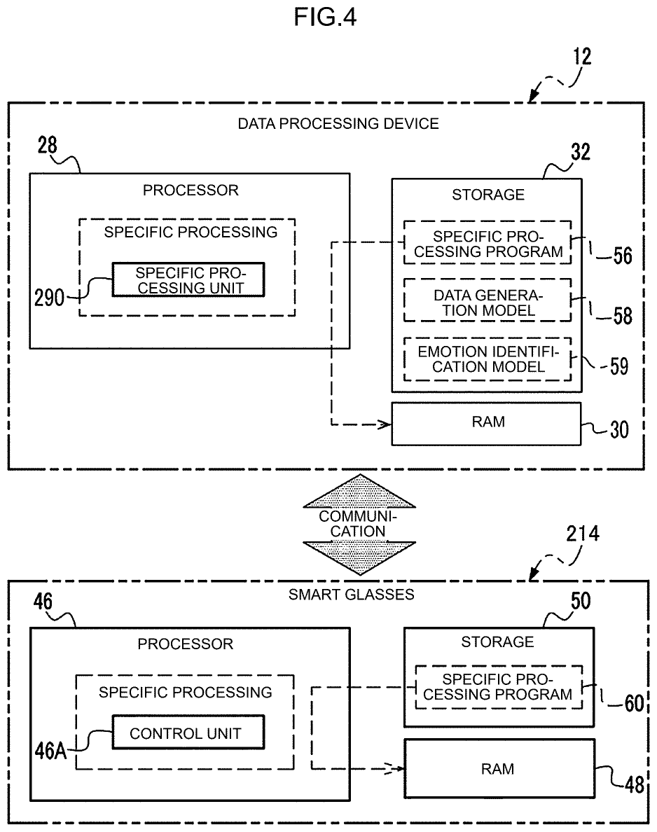

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, generation unit, display unit, and editing unit is implemented by at least one of, for example, smart glasses 214 and a data processing apparatus 12. For example, the receiving unit is implemented by a control unit 46A of the smart glasses 214, allowing a user to upload a PDF file or URL. The generation unit is implemented, for example, by a specific processing unit 290 of the data processing apparatus 12, and analyzes the uploaded document using generative AI to generate a summary in response to a request. The display unit is implemented, for example, by a speaker 240 of the smart glasses 214, and displays the generated summary on a chat screen. The editing unit is implemented, for example, by the control unit 46A of the smart glasses 214, and provides an editing screen for the user to create a document based on the summary. The correspondence between each unit and the device or control unit is not limited to the examples described above and various modifications are possible.

### Third Embodiment

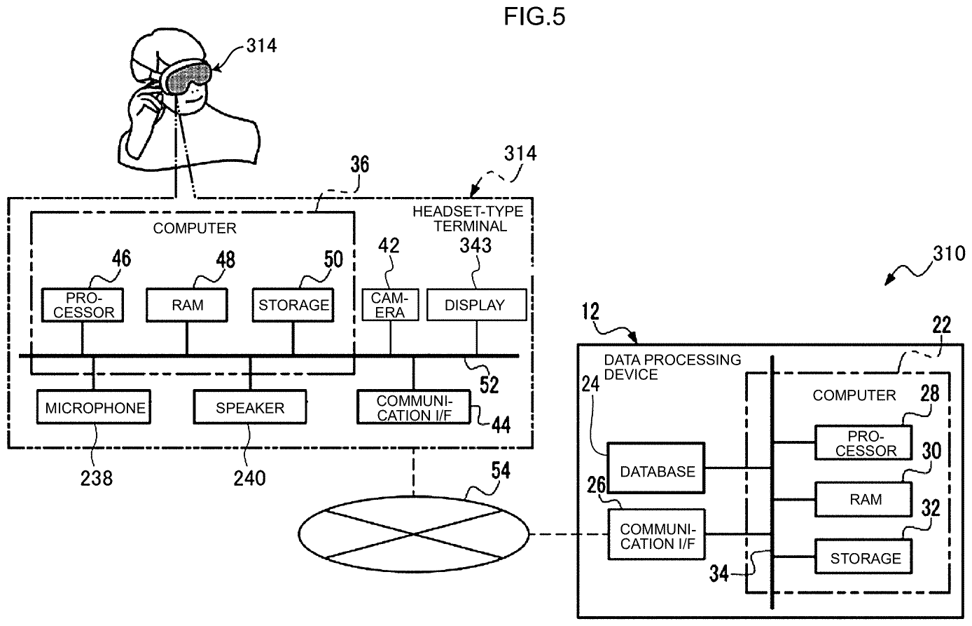

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

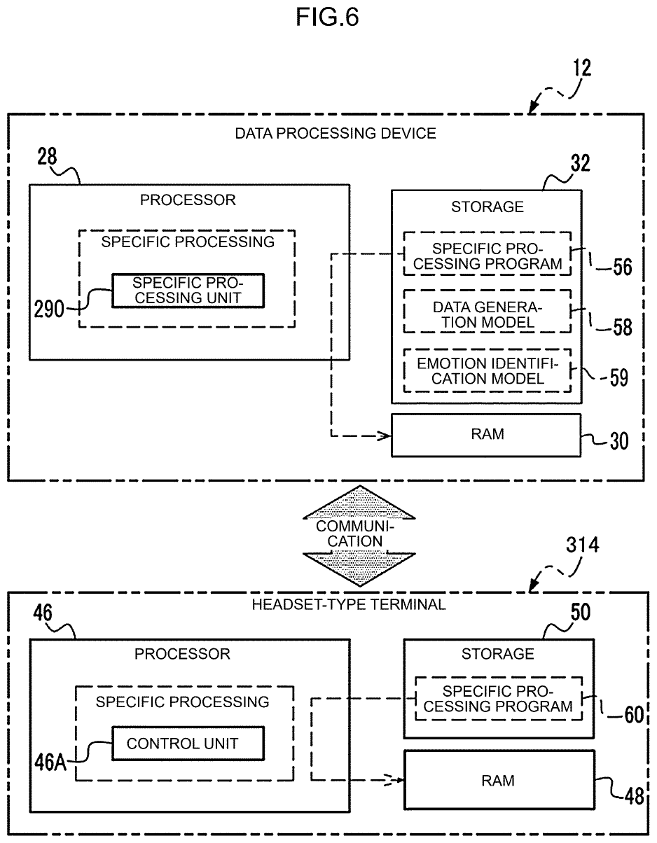

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, generation unit, display unit, and editing unit is implemented by at least one of, for example, a headset-type terminal 314 and a data processing apparatus 12. For example, the receiving unit is implemented by a control unit 46A of the headset-type terminal 314, allowing a user to upload a PDF file or URL. The generation unit is implemented, for example, by a specific processing unit 290 of the data processing apparatus 12, and analyzes the uploaded document using generative AI to generate a summary in response to a request. The display unit is implemented, for example, by a display 343 of the headset-type terminal 314, and displays the generated summary on a chat screen. The editing unit is implemented, for example, by the control unit 46A of the headset-type terminal 314, and provides an editing screen for the user to create a document based on the summary. The correspondence between each unit and the device or control unit is not limited to the examples described above and various modifications are possible.

### Fourth Embodiment

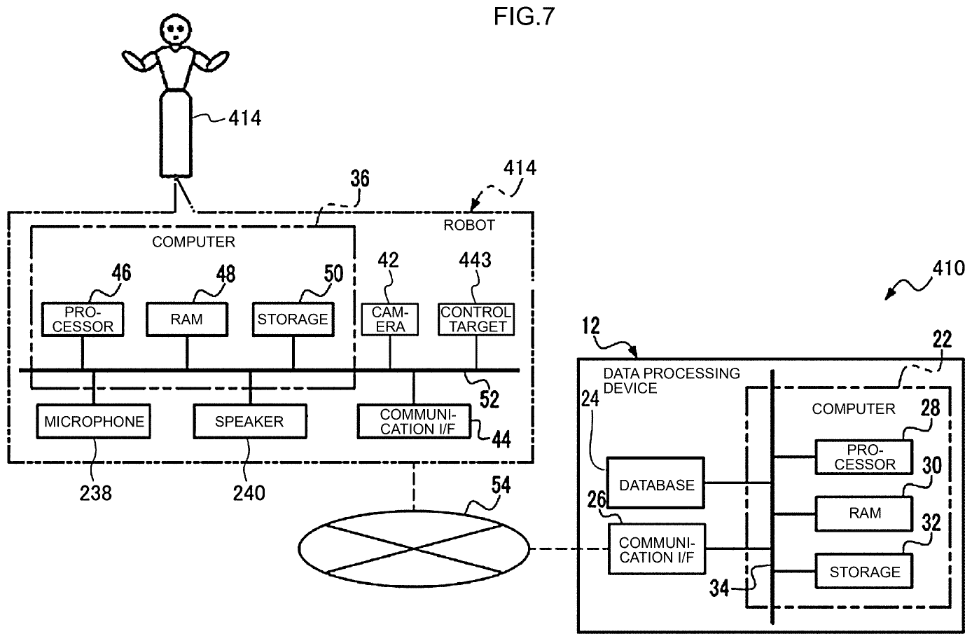

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

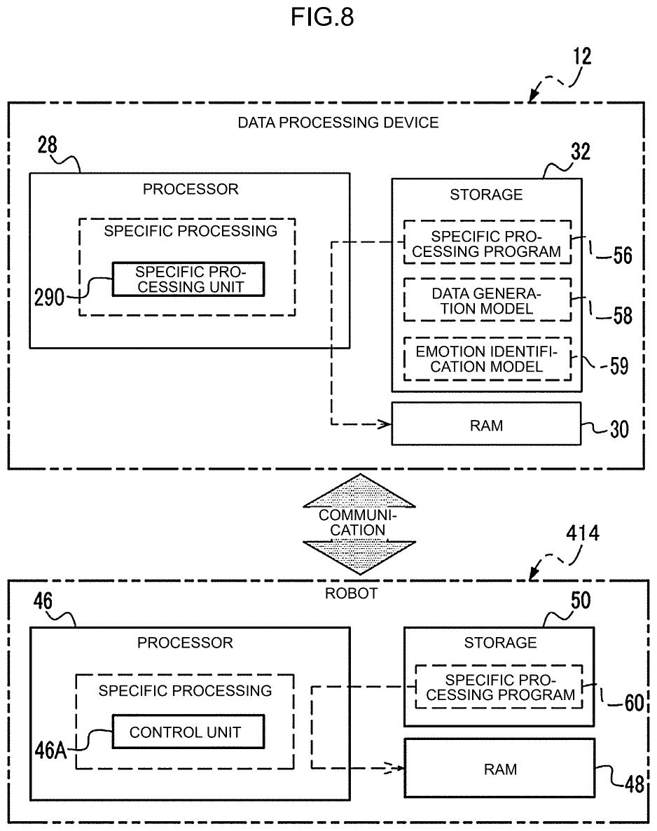

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, generation unit, display unit, and editing unit is implemented by at least one of, for example, a robot 414 and a data processing apparatus 12. For example, the receiving unit is implemented by a control unit 46A of the robot 414, allowing a user to upload a PDF file or URL. The generation unit is implemented, for example, by a specific processing unit 290 of the data processing apparatus 12, and analyzes the uploaded document using generative AI to generate a summary in response to a request. The display unit is implemented, for example, by a speaker 240 of the robot 414, and displays the generated summary on a chat screen. The editing unit is implemented, for example, by the control unit 46A of the robot 414, and provides an editing screen for the user to create a document based on the summary. The correspondence between each unit and the device or control unit is not limited to the examples described above and various modifications are possible.

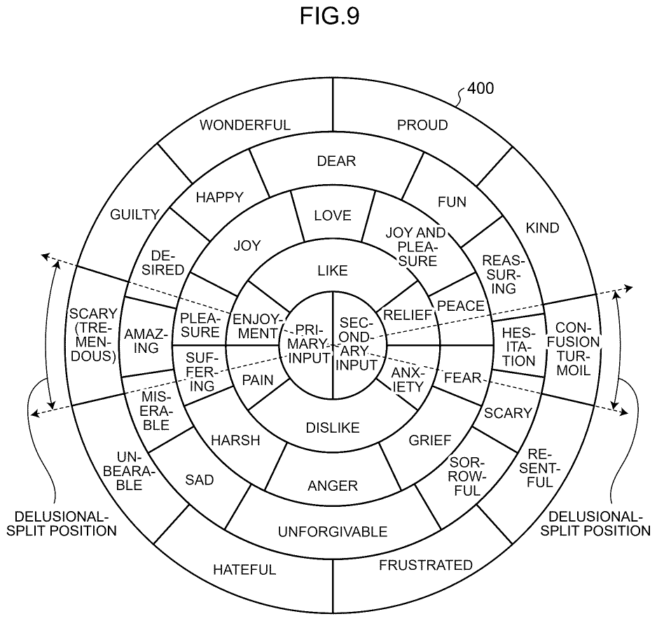

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

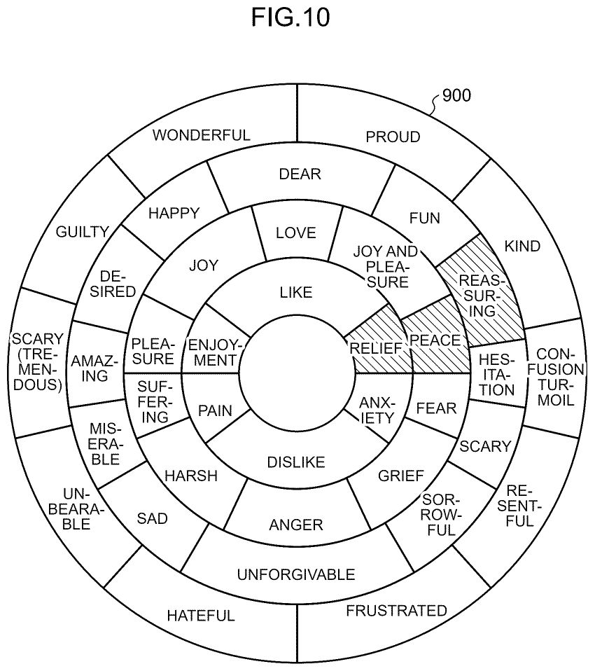

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a receiving unit configured to receive an uploaded PDF file or URL; a generation unit configured to analyze a document uploaded by the receiving unit and generate a summary based on a request; a display unit configured to display the summary generated by the generation unit on a chat screen; and an editing unit configured to create a document based on the summary generated by the generation unit.

(Supplementary Note 2) The system according to Supplementary Note 1, wherein the receiving unit is configured to allow a user to upload a PDF file or URL.

(Supplementary Note 3) The system according to Supplementary Note 1, wherein the generation unit is configured to analyze a document uploaded by a generative AI and generate a summary in response to a request.

(Supplementary Note 4) The system according to Supplementary Note 1, wherein the display unit is configured to display a summary created by a generative AI on a chat screen.

(Supplementary Note 5)The system according to Supplementary Note 1, wherein the editing unit is configured to provide an editing screen for a user to create a document based on the summary.

(Supplementary Note 6) The system according to Supplementary Note 1, wherein the display unit is configured to display the original page of the PDF or URL.

(Supplementary Note 7) The system according to Supplementary Note 1, wherein the receiving unit is configured to estimate a user's emotion and adjust the timing of uploading based on the estimated emotion of the user.

(Supplementary Note 8) The system according to Supplementary Note 1, wherein the receiving unit is configured to analyze a user's past upload history and select an optimal upload method.

(Supplementary Note 9)The system according to Supplementary Note 1, wherein the receiving unit is configured to perform filtering at the time of uploading based on a user's current project or field of interest.

(Supplementary Note 10) The system according to Supplementary Note 1, wherein the receiving unit is configured to estimate a user's emotion and determine the priority of documents to be uploaded based on the estimated emotion of the user.

(Supplementary Note 11) The system according to Supplementary Note 1, wherein the receiving unit is configured to preferentially upload relevant documents by considering a user's geographic location information at the time of uploading.

(Supplementary Note 12) The system according to Supplementary Note 1, wherein the receiving unit is configured to analyze a user's social media activity at the time of uploading and upload relevant documents.

(Supplementary Note 13) The system according to Supplementary Note 1, wherein the generation unit is configured to estimate a user's emotion and adjust the expression method of the summary based on the estimated emotion of the user.

(Supplementary Note 14) The system according to Supplementary Note 1, wherein the generation unit is configured to adjust the level of detail of the summary based on the importance of the document at the time of summary generation.

(Supplementary Note 15) The system according to Supplementary Note 1, wherein the generation unit is configured to apply different summary algorithms according to the category of the document at the time of summary generation.

(Supplementary Note 16) The system according to Supplementary Note 1, wherein the generation unit is configured to estimate a user's emotion and adjust the length of the summary based on the estimated emotion of the user.

(Supplementary Note 17) The system according to Supplementary Note 1, wherein the generation unit is configured to determine the priority of the summary based on the submission timing of the document at the time of summary generation.

(Supplementary Note 18) The system according to Supplementary Note 1, wherein the generation unit is configured to adjust the order of the summary based on the relevance of the document at the time of summary generation.

(Supplementary Note 19) The system according to Supplementary Note 1, wherein the display unit is configured to estimate a user's emotion and adjust the display method of the summary based on the estimated emotion of the user.

(Supplementary Note 20) The system according to Supplementary Note 1, wherein the display unit is configured to select an optimal display method by referring to a user's past operation history at the time of summary display.

(Supplementary Note 21) The system according to Supplementary Note 1, wherein the display unit is configured to adjust the display priority based on the importance of the document at the time of summary display.

(Supplementary Note 22) The system according to Supplementary Note 1, wherein the display unit is configured to estimate a user's emotion and adjust the display order of the summary based on the estimated emotion of the user.

(Supplementary Note 23) The system according to Supplementary Note 1, wherein the display unit is configured to select an optimal display method by considering a user's device information at the time of summary display.

(Supplementary Note 24) The system according to Supplementary Note 1, wherein the display unit is configured to preferentially display relevant summaries by considering a user's geographic location information at the time of summary display.

(Supplementary Note 25) The system according to Supplementary Note 1, wherein the editing unit is configured to estimate a user's emotion and adjust the display method of the editing screen based on the estimated emotion of the user.

(Supplementary Note 26) The system according to Supplementary Note 1, wherein the editing unit is configured to select an optimal display method by referring to a user's past editing history at the time of editing screen display.

(Supplementary Note 27) The system according to Supplementary Note 1, wherein the editing unit is configured to provide different editing tools according to the category of the document at the time of editing screen display.

(Supplementary Note 28) The system according to Supplementary Note 1, wherein the editing unit is configured to estimate a user's emotion and adjust the operation procedure of the editing screen based on the estimated emotion of the user.

(Supplementary Note 29) The system according to Supplementary Note 1, wherein the editing unit is configured to select an optimal display method by considering a user's device information at the time of editing screen display.

(Supplementary Note 30) The system according to Supplementary Note 1, wherein the editing unit is configured to provide relevant editing tools by considering a user's geographic location information at the time of editing screen display.

What is claimed is:

1. A system comprising:
circuitry configured to:
receive electronic document data from a client terminal via a communication interface;
extract text data from the electronic document data by applying an optical character recognition model;
generate a feature vector by inputting the extracted text data into a text embedding model;
generate summary data by inputting the feature vector into a text generation model trained on a neural network; and
transmit the summary data to the client terminal for display on a graphical user interface.

2. The system according to claim 1, wherein the electronic document data comprises at least one of a portable document format file or hypertext markup language data obtained from a uniform resource locator.

3. The system according to claim 1, wherein the circuitry is further configured to parse the hypertext markup language data to extract a main text portion by applying a document object model parsing algorithm.

4. The system according to claim 1, wherein the text generation model comprises a large language model having a Transformer architecture with an attention mechanism configured to calculate importance scores for sentences in the extracted text data.

5. The system according to claim 1, wherein the circuitry is further configured to generate the summary data in a format specified by a user request, the format comprising at least one of a text summary, a bullet point list, or tagged structured data.

6. The system according to claim 1, wherein the circuitry is further configured to transmit original page data of the electronic document data together with the summary data, such that the client terminal displays the summary data and the original page data simultaneously.

7. The system according to claim 1, wherein the circuitry is further configured to estimate an emotion of a user by applying an emotion identification model to sensor data received from the client terminal, and to adjust an expression method of the summary data based on the estimated emotion.

8. The system according to claim 7, wherein the circuitry is configured to generate a detailed summary when the estimated emotion indicates relaxation, and to generate a concise summary when the estimated emotion indicates urgency.

9. The system according to claim 1, wherein the circuitry is further configured to analyze a past upload history of a user stored in a database, and to select an upload method for the electronic document data based on the past upload history.

10. The system according to claim 1, wherein the circuitry is further configured to filter the electronic document data at a time of receiving based on a current project or field of interest of a user, such that document data having a relevance score above a threshold is prioritized.

11. The system according to claim 1, wherein the circuitry is further configured to adjust a level of detail of the summary data based on an importance score calculated for the electronic document data.

12. The system according to claim 1, wherein the circuitry is further configured to apply different summarization algorithms according to a category of the electronic document data, such that meeting minutes are processed with an agenda extraction algorithm and research papers are processed with a conclusion extraction algorithm.

13. The system according to claim 1, wherein the circuitry is further configured to determine a display format for the summary data by inputting the summary data and device information of the client terminal into a user interface optimization model.

14. The system according to claim 1, wherein the circuitry is further configured to transmit editing screen data to the client terminal, the editing screen data enabling a user to create a document based on the summary data using at least one of a text editor, a slide creation tool, or a code editor.

15. The system according to claim 14, wherein the circuitry is further configured to provide an auto-completion function by inputting a partial input from the user into the text generation model and transmitting a generated completion to the client terminal.

16. The system according to claim 1, wherein the circuitry is further configured to adjust a display priority of the summary data based on a submission timing associated with the electronic document data.

17. The system according to claim 1, wherein the circuitry is further configured to select editing tools to transmit to the client terminal based on a geographic location of the client terminal, such that region-specific document templates are prioritized.

18. A system comprising:
a communication interface configured to communicate with a client terminal via a network;
a memory storing a text generation model trained on a neural network, a text embedding model, and an emotion identification model; and
a processor coupled to the communication interface and the memory, the processor configured to:
receive electronic document data from the client terminal via the communication interface;
extract text data from the electronic document data;
generate a feature vector by inputting the extracted text data into the text embedding model;
estimate an emotion of a user by applying the emotion identification model to sensor data received from the client terminal;
generate summary data by inputting the feature vector and the estimated emotion into the text generation model, wherein an expression method of the summary data is adjusted based on the estimated emotion; and
transmit the summary data to the client terminal via the communication interface for display on a graphical user interface.

19. The system according to claim 18, wherein the processor is further configured to transmit editing screen data to the client terminal, the editing screen data comprising a user interface layout adjusted based on the estimated emotion, such that a simplified interface is provided when the estimated emotion indicates stress and a detailed interface is provided when the estimated emotion indicates relaxation.

20. A method performed by a system comprising circuitry, the method comprising:
receiving electronic document data from a client terminal via a communication interface;
extracting text data from the electronic document data by applying an optical character recognition model;
generating a feature vector by inputting the extracted text data into a text embedding model;
generating summary data by inputting the feature vector into a text generation model trained on a neural network; and
transmitting the summary data to the client terminal for display on a graphical user interface.
